(19) United States
(12) Patent Application Publication
(10) Pub. No.: US 2020/0007946 A1
(43) Pub. Date: Jan. 2, 2020

(54) SELECTIVELY DELIVERING A TRANSLATION FOR A MEDIA ASSET BASED ON USER PROFICIENCY LEVEL IN THE FOREIGN LANGUAGE AND PROFICIENCY LEVEL REQUIRED TO COMPREHEND THE MEDIA ASSET

(71) Applicant: Rovi Guides, Inc., San Jose, CA (US)

(72) Inventor: Lev Olkha, Los Angeles, CA (US)

(21) Appl. No.: 16/023,608

(22) Filed: Jun. 29, 2018

(51) Int. Cl. H04N 21/485; G06F 17/28; H04N 21/45

(52) U.S. Cl. CPC H04N 21/4856; H04N 21/4532; G06F 17/289

(57) ABSTRACT

Methods and systems are described herein for a media guidance application that selectively provides a translation corresponding to a media asset based on a level of proficiency of the language required to comprehend the media asset and a level of proficiency of the user corresponding to the language. The media guidance application provides an output comprising the translation in response to determining that the level of proficiency of the user is lower than the level of proficiency of the language required to comprehend the media asset.

### BACKGROUND

Oftentimes, a user may watch media content that is in a language not native to the user. For example, a user may watch popular media assets on a social media platform, such as YouTube®, where the primary language spoken in the video is French. A user who is fluent in English, but only has a working knowledge of French, may not be able to fully comprehend and enjoy the video content. Although the user may select the option to display a subtitle track in English to better comprehend and enjoy the video content, that requires the user to navigate to the options menu to select the appropriate subtitle track. Moreover, when the user decides to watch a subsequent media asset, the primary language of which is also French but requires only minimal knowledge of the language to comprehend the video, the user may find the subtitle track distracting and may have to navigate to the options menu again to turn off the subtitle track. If the user is required to navigate to the options menu each time they wish to watch a video, the user may have a subpar viewing experience and become disinterested in watching the video content.

### SUMMARY

The present disclosure describes systems and methods for automatically providing a translation of the media content in a language that is native to the user when the user is unable to sufficiently comprehend the media content in its original language.

A suitable application, such as a media guidance application, compares a language proficiency level required to comprehend the media content and the language proficiency level of the user to determine whether to automatically provide translations. A suitable application may be any application that allows a user to select a media asset, compare a language proficiency level required to comprehend the media asset and the language proficiency level of the user to determine whether to automatically provide translations, and selectively deliver an output comprising the translation. For example, the suitable application may be a web browser that allows the user to select a media asset for viewing (e.g., Chrome® browser which allows users access to videos uploaded on social media platforms such as YouTube®, etc.). In some embodiments, the suitable application may be an application configured to receive live and/or non-live content from an over-the-top (OTT) content provider (e.g., Netflix®, Hulu®, Amazon Prime®, etc.). In some embodiments, the suitable application may be a media guidance application.

Specifically, the media guidance application determines a level of proficiency of a language required to comprehend the media content, a level of proficiency of the user in the language, and determines whether the level of proficiency of the language required to comprehend the media content is equal to, higher than, or lower than the level of proficiency of the user. In response to determining that the level of proficiency of the user is lower than the level of proficiency of the language required to comprehend the media content, the media guidance application provides a translation in a language native to the user; otherwise the media guidance application displays the media content without the translation. Accordingly, the user is able to fully comprehend the media content without needing to navigate to the options menu each time they wish to watch media content in a non-native language.

For example, the media guidance application may determine (e.g., using control circuitry on a first device) a language spoken in a media asset (e.g., based on metadata corresponding to the media asset). The media guidance application may also retrieve a profile of a user viewing the media asset stored on the first device, and determine whether the language spoken in the media asset is a language native to the user (e.g., based on the user profile which may list the languages native to the user). The media guidance application may, in response to determining that the language is not native to the user, determine a level of proficiency of the language required to comprehend the media asset (e.g., based on metadata corresponding to the media asset) and determine a level of proficiency of the user corresponding to the language (e.g., based on the user profile). The media guidance application may determine (e.g., using control circuitry on the first device) whether the level of proficiency of the language required to comprehend the media asset is equal to, higher than, or lower than the level of proficiency of the user. In response to determining that the level of proficiency of the user is equal to or higher than the level of proficiency of the language required to comprehend the media asset, the media guidance application may generate an output comprising the media asset at the first device. In response to determining that the level of proficiency of the user is lower than the level of proficiency of the language required to comprehend the media asset, the media guidance application may request a translation to a language native to the user from a cloud server, and responsive to receiving the translation from the cloud server, generate a display comprising the translation at the first device.

As an example, a user may decide to watch the French movie “Jour de fête.” The media guidance application, using control circuitry, may read and interpret metadata associated with the movie to determine that the primary language spoken in the movie is French. In some embodiments, the metadata associated with the movie may include the language spoken in the movie, and the media guidance application may, via the control circuitry, read and interpret the metadata to make the determination of the language spoken in the movie. In some embodiments, the media guidance application may determine the language spoken in the movie based on a country of origin of the movie. For example, the media guidance application, based on the metadata corresponding to the movie, may determine that the movie was created in France. In response to determining that the movie originated in France, the media guidance application may determine that French is the national language spoken in France, and therefore, the language spoken in the movie is likely French.

The media guidance application may access a profile for the user viewing the movie. In some embodiments, the user profile may be stored in a database on a cloud server. In some embodiments, the media guidance application may access a profile for the user viewing the movie stored on a first device on which the user is viewing the movie. The media guidance application may, using the control circuitry, determine whether French is a language native to the user. For example, the user profile stored on a database may include a list of languages native to the user. If the user is a native speaker of French, the media guidance application determines that a translation is not required for the user to comprehend the movie. Therefore, the media guidance application may generate, for display, the movie without a translation on the first device. In response to determining that the user is not a native speaker of French, the media guidance application may determine a level of proficiency required to comprehend the movie. For example, the user profile stored on the database may indicate that the languages native to the user are English and Spanish.

In response to determining that French is not native to the user, the media guidance application, via control circuitry, may determine the level of proficiency in French that is required to comprehend the movie “Jour de fête” based on the metadata corresponding to the movie. In some embodiments, the media guidance application, using the control circuitry, may determine the level of proficiency in the language by analyzing the words spoken in the media asset. For example, the media guidance application, based on the metadata using the control circuitry, may generate a list of most frequently used words and/or phrases in the movie. For example, the metadata may include a subtitle file that includes all the words spoken in the movie. In an example, the user may wish to watch a foreign-language video uploaded on YouTube® by another user, and the video metadata may not include a subtitle file corresponding to the video. In such a case, the media guidance application, via control circuitry, may transcribe the audio file to generate a corresponding text file. The media guidance application, via control circuitry, may assign each of the most frequently used words and/or phrases into one of a plurality of groups corresponding to various proficiency levels required to comprehend the words and/or phrases in the language. For example, the media guidance application may group the list of most frequently used words and/or phrases into five groups: (1) Native Speaker; (2) Very Good Command; (3) Working Knowledge; (4) Beginner; and (5) Non-Speaker, based on the proficiency levels required to comprehend the words and/or phrases in the language. In some embodiments, the metadata corresponding to the movie may include an indication of the level of proficiency of the language required to comprehend the movie. The media guidance application, via control circuitry, may determine the level of proficiency of the language required to comprehend the movie based on the metadata corresponding to the movie. It will be evident to a person possessing ordinary skill in the art that any number of groups may be chosen to provide additional granularity in determining the level of proficiency of the language required to comprehend the media asset.

Moreover, the media guidance application, via control circuitry, may determine a level of proficiency of the user corresponding to the language. For example, the media guidance application, via control circuitry, may determine the level of proficiency of the user in French if the user wishes to watch the movie “Jour de fete,” and the user is not a native French speaker. In some embodiments, the media guidance application, via control circuitry, may generate a prompt requesting the user to input a level of proficiency of the user corresponding to the language. For example, the media guidance application, via control circuitry, may generate a prompt on the first device that requests the user to select one of five user-selectable options: (1) Native Speaker; (2) Very Good Command; (3) Working Knowledge; (4) Beginner; and (5) Non-Speaker. For example, the user may select the user-selectable option (3) Working Knowledge in response to the prompt. It will be evident to a person possessing ordinary skill in the art that any number of groups may be chosen to provide additional granularity in determining the level of proficiency of the user corresponding to the language. In response to receiving the user input, the media guidance application, via control circuitry, may store the user selection as the level of proficiency of the user corresponding to the language in the user profile on a database stored in a remote cloud server and/or the first device.

In some embodiments, the media guidance application, via control circuitry, may determine the level of proficiency of the user corresponding to the language based on the information stored in the user profile. In some embodiments, the media guidance application, via control circuitry, may determine the level of proficiency of the user corresponding to the language based on online activity of the user. For example, the user profile information stored in the database may include browsing history of the user. The media guidance application, via control circuitry, may correlate a total number of hours spent on websites in the foreign language with a corresponding proficiency level. For example, if the user has spent more than 20 hours in a week browsing websites that have content in French, the media guidance application may classify the user as being a native speaker of French. If the user has spent more than 10 hours but less than 20 hours in a week browsing websites that have content in French, the media guidance application may classify the user as having a very good command of French. If the user has spent more than 5 hours but less than 10 hours in a week browsing websites that have content in French, the media guidance application may classify the user as having a working knowledge of French. If the user has spent more than an hour but less than 5 hours in a week browsing websites that have content in French, the media guidance application may classify the user as being a beginner in learning French. If the user has browsed websites with content in French only on occasion, the media guidance application may classify the user as a non-speaker of French.

In some embodiments, the media guidance application, via control circuitry, may determine the level of proficiency of the user corresponding to the language based on a media asset viewing history of the user. For example, the user profile information stored in the database may include a total number of hours spent viewing a media asset in the language within a predetermined amount of time. The media guidance application, via control circuitry, may correlate a total number of hours spent viewing media assets in the foreign language with a corresponding proficiency level. For example, if the user has spent more than 20 hours in a week viewing media assets that have content in French, the media guidance application may classify the user as being a native speaker of French. If the user has spent more than 10 hours but less than 20 hours in a week viewing media assets that have content in French, the media guidance application may classify the user as having a very good command of French. If the user has spent more than 5 hours but less than 10 hours in a week viewing media assets that have content in French, the media guidance application may classify the user as having a working knowledge of French. If the user has spent more than an hour but less than 5 hours in a week viewing media assets that have content in French, the media guidance application may classify the user as being a beginner in learning French. If the user has viewed media assets with content in French only on occasion, the media guidance application may classify the user as a non-speaker of French.

In some embodiments, the media guidance application, via control circuitry, may determine the level of proficiency of the user corresponding to the language based on a music selection history of the user. For example, the user profile information stored in the database may include a total number of hours spent listening to music in the language within a predetermined amount of time. The media guidance application, via control circuitry, may correlate a total number of hours spent listening to musical assets that are in the foreign language with a corresponding proficiency level. For example, if the user has spent more than 20 hours in a week listening to musical assets that are in French, the media guidance application may classify the user as being a native speaker of French. If the user has spent more than 10 hours but less than 20 hours in a week listening to musical assets that are in French, the media guidance application may classify the user as having a very good command of French. If the user has spent more than 5 hours but less than 10 hours in a week listening to musical assets that are in French, the media guidance application may classify the user as having a working knowledge of French. If the user has spent more than an hour but less than 5 hours in a week listening to musical assets that are in French, the media guidance application may classify the user as being a beginner in learning French. If the user has listened to musical assets that are in French only on occasion, the media guidance application may classify the user as a non-speaker of French.

In some embodiments, the media guidance application, via control circuitry, may determine the level of proficiency of the user corresponding to the language based on an amount of time spent reading a text item written in the language. For example, the user profile information stored in the database may include a total number of hours spent reading a text item written in the language within a predetermined amount of time. The media guidance application, via control circuitry, may correlate a total number of hours spent reading a text item written in the foreign language with a corresponding proficiency level. For example, if the user has spent more than 20 hours in a week reading a text item written in French, the media guidance application may classify the user as being a native speaker of French. If the user has spent more than 10 hours but less than 20 hours in a week reading a text item written in French, the media guidance application may classify the user as having a very good command of French. If the user has spent more than 5 hours but less than 10 hours in a week reading a text item written in French, the media guidance application may classify the user as having a working knowledge of French. If the user has spent more than an hour but less than 5 hours in a week reading a text item written in French, the media guidance application may classify the user as being a beginner in learning French. If the user has read a text item written in French only on occasion, the media guidance application may classify the user as a non-speaker of French.

In some embodiments, the media guidance application, via control circuitry, may determine the level of proficiency of the user corresponding to the language based on an amount of time spent creating a text item written in the language. For example, the user profile information stored in the database may include a total number of hours spent creating a text item written in the language within a predetermined amount of time. The media guidance application, via control circuitry, may correlate a total number of hours spent creating a text item written in the foreign language with a corresponding proficiency level. For example, if the user has spent more than 20 hours in a week creating a text item written in French, the media guidance application may classify the user as being a native speaker of French. If the user has spent more than 10 hours but less than 20 hours in a week creating a text item written in French, the media guidance application may classify the user as having a very good command of French. If the user has spent more than 5 hours but less than 10 hours in a week creating a text item written in French, the media guidance application may classify the user as having a working knowledge of French. If the user has spent more than an hour but less than 5 hours in a week creating a text item written in French, the media guidance application may classify the user as being a beginner in learning French. If the user has created a text item written in French only on occasion, the media guidance application may classify the user as a non-speaker of French.

In some embodiments, the media guidance application, via control circuitry, may determine the level of proficiency of the user corresponding to the language based on an amount of time spent editing a text item written in the language. For example, the user profile information stored in the database may include a total number of hours spent editing a text item written in the language within a predetermined amount of time. The media guidance application, via control circuitry, may correlate a total number of hours spent editing a text item written in the foreign language with a corresponding proficiency level. For example, if the user has spent more than 20 hours in a week editing a text item written in French, the media guidance application may classify the user as being a native speaker of French. If the user has spent more than 10 hours but less than 20 hours in a week editing a text item written in French, the media guidance application may classify the user as having a very good command of French. If the user has spent more than 5 hours but less than 10 hours in a week editing a text item written in French, the media guidance application may classify the user as having a working knowledge of French. If the user has spent more than an hour but less than 5 hours in a week editing a text item written in French, the media guidance application may classify the user as being a beginner in learning French. If the user has edited a text item written in French only on occasion, the media guidance application may classify the user as a non-speaker of French.

In some embodiments, the media guidance application, via control circuitry, may determine the level of proficiency of the user corresponding to the language based on previous requests for subtitles submitted by the user. For example, the user profile information stored in the database may include an indication of how often the user has requested subtitles when viewing a media asset in the language within a predetermined amount of time. The media guidance application, via control circuitry, may correlate a total number of times the user requested subtitles in the foreign language with a corresponding proficiency level. For example, if the user has requested subtitles when viewing content in French less than 25% of the time, the media guidance application may classify the user as being a native speaker of French. If the user has requested subtitles when viewing content in French less than 50% but more than 25%, the media guidance application may classify the user as having a very good command of French. If the user has requested subtitles when viewing content in French less than 75% but more than 50%, the media guidance application may classify the user as having a working knowledge of French. If the user has requested subtitles when viewing content in French less than 100% but more than 75%, the media guidance application may classify the user as being a beginner in learning French. If the user has always requested subtitles when viewing a media asset in French, the media guidance application may classify the user as a non-speaker of French.

It will be evident to a person possessing ordinary skill in the art that the ranges provided above are merely examples, and that any suitable time period may be chosen over which to monitor a user's online activity, media asset viewing history, music selection history, text item reading history, text item creating history, and text item editing history for a particular language, and that various suitable thresholds may be selected for determining the level of proficiency of the user corresponding to the language.

In some embodiments, the media guidance application, implemented on control circuitry, may present a language fluency test to determine the level of proficiency of the user corresponding to the language. For example, the media guidance application, via control circuitry, may generate for display a test with user-selectable answers that test the user's proficiency levels in French.

The media guidance application, via control circuitry, may determine whether the level of proficiency of the language required to comprehend the media asset is equal to, higher than, or lower than the level of proficiency of the user. For example, the media guidance application may determine whether the level of proficiency of French required to comprehend the movie “Jour de fête” is equal to, higher than, or lower than the level of proficiency of the user in French. In response to determining that the level of proficiency of the user is equal to or higher than the level of proficiency of the language required to comprehend the media asset, the media guidance application, via control circuitry, may generate an output comprising the media asset. For example, in response to determining that the level of proficiency of the user in French is equal to or higher than the level of proficiency of French required to comprehend the movie “Jour de fête,” the media guidance application, via control circuitry, may generate for display, at the first device, the movie to be viewed by the user without a translation. In some embodiments, the movie includes a video file and an audio file corresponding to the video file. The media guidance application, via control circuitry, streams both the video file and the audio file to the first device accessible by the user, and generates, for display on the first device, the movie.

In response to determining that the level of proficiency of the user is lower than the level of proficiency of the language required to comprehend the media asset, the media guidance application, via control circuitry, may request a translation to a language native to the user. For example, in response to determining that the level of proficiency of the user in French is lower than the level of proficiency of French required to comprehend the movie “Jour de fete,” the media guidance application, via control circuitry, may request a translation from a cloud server in a language native to the user corresponding to the movie (e.g., English or Spanish). In some embodiments, the translation may comprise a subtitle track, closed-captioning track, and/or an audio recording in the native language. For example, the translation may include an audio translation of the movie in English or Spanish. In another example, the translation may include a subtitle file which includes an English or Spanish translation of the movie. In some embodiments, the media guidance application may retrieve a language track comprising an audio translation of the media asset in a language native to the user from metadata corresponding to the media asset.

In response to receiving the translation from the cloud server, the media guidance application, via control circuitry, may generate for display an output comprising the translation. For example, the media guidance application, via control circuitry, may generate for display at the first device the video file of the movie along with the translation received from the cloud server. In some embodiments, the media guidance application, via control circuitry, may generate a display comprising a visual representation of the audio file synchronized with the video file in addition to streaming the audio file and the video file corresponding to the media asset. For example, the media guidance application, via control circuitry, may generate for display at the first device a subtitle file displayed in synchronization with the audio file and the video file of the movie “Jour de fête.”

In some embodiments, the media guidance application, via control circuitry, may replace the audio file corresponding to the media asset with a second audio file, where the second audio file is a translation of the audio file of the media asset in a language native to the user. For example, the media guidance application may replace the audio file corresponding to the movie “Jour de fête” with the second audio file comprising an English or Spanish translation of the audio file corresponding to the movie. In some embodiments, the media guidance application, via control circuitry, may stream the video file corresponding to the media asset along with the second audio file to be displayed at the first device. For example, the media guidance application may generate, for display at the first device, the video file corresponding to the movie “Jour de fête” along with an English or Spanish translation dubbed over the original audio file.

By the media guidance application automatically determining whether the level of proficiency of the language required to comprehend the media asset is equal to, higher than, or lower than the level of proficiency of the user, and responsive to the determination, providing an appropriate output to the user (with a translation when the level of proficiency of the language required to comprehend the media asset is higher than the level of proficiency of the user; otherwise without the translation), the user is spared the inconvenience of having to manually request or remove subtitles for each media content viewing. The user viewing experience is therefore improved.

It should also be noted that the systems, methods, apparatuses, and/or aspects described above may be applied to, or used in accordance with, other systems, methods, apparatuses, and/or aspects.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a first device displaying a media asset in a foreign language, in accordance with some embodiments of the disclosure;

FIG. 2 shows an illustrative example of a media guidance display that may be presented in accordance with some embodiments of the disclosure;

FIG. 3 shows another illustrative example of a media guidance display that may be presented in accordance with some embodiment of the disclosure;

FIG. 4 is a block diagram of an illustrative user equipment device, in accordance with some embodiments of the disclosure;

FIG. 5 is a block diagram of an illustrative media system, in accordance with some embodiments of the disclosure;

FIG. 6 is a flowchart of illustrative steps for providing an output comprising a translation, in accordance with some embodiments of the disclosure;

FIG. 7 is a flowchart of illustrative steps for identifying a language spoken in a media asset, in accordance with some embodiments of the disclosure;

FIG. 8 is another flowchart of illustrative steps for identifying a language spoken in a media asset, in accordance with some embodiments of the disclosure;

FIG. 9 shows an illustrative example of a user profile, in accordance with some embodiments of the disclosure;

FIG. 10 shows an illustrative example of a suitable application configuration, in accordance with some embodiments of the disclosure;

FIG. 11 shows another illustrative example of a user profile, in accordance with some embodiments of the disclosure;

FIG. 12 is another flowchart of illustrative steps for identifying a level of proficiency of the user corresponding to a language, in accordance with some embodiments of the disclosure;

FIG. 13 is a flowchart of illustrative steps for identifying a level of proficiency of the user corresponding to a language, in accordance with some embodiments of the disclosure;

FIG. 14 is an illustrative example of a keyword data table for identifying a level of proficiency of a language required to comprehend a media asset, in accordance with some embodiments of the disclosure;

FIG. 15 is a flowchart of illustrative steps for identifying a level of proficiency of a language required to comprehend a media asset, in accordance with some embodiments of the disclosure;

FIG. 16 is a graphical representation of a keyword analysis for identifying a level of proficiency of a language required to comprehend a media asset, in accordance with some embodiments of the disclosure;

FIG. 17 shows another illustrative example of a suitable application configuration, in accordance with some embodiments of the disclosure; and

FIG. 18 shows yet another illustrative example of a suitable application configuration, in accordance with some embodiments of the disclosure.

### DETAILED DESCRIPTION

The advancement of digital transmission of media content has increased the amount of data that can be transmitted. In particular, media systems may transmit metadata that include detailed information about media content. This metadata may include descriptions related to the primary language spoken in the media content and may provide a language track associated with the media content. While this information, by itself, is not useable for displaying to a human user, computer processors can read and interpret this information. However, while computer processors may read and interpret this information, and generate media content for display that may be useable by a human user (e.g., output a subtitle track or closed-captioning track on a display screen in a human recognizable format), these systems still fail to solve the aforementioned problem when implemented in computer systems because a subtitle track automatically generated by the computer processor, based on received metadata, still fails to account for the problems created when providing the translations in computer systems: (i) that a user may be required to navigate to an options menu and select the subtitle track if they are unable to comprehend the media content; and (ii) that a user may be required to navigate to the options menu again to turn off the subtitle track if they are able to comprehend a subsequent media asset in the same language and find the subtitle track distracting.

Systems and methods are described herein for a suitable application that compares a language proficiency level required to sufficiently comprehend a media asset and the language proficiency level of the user to determine whether to automatically provide translations. A suitable application may be any application that allows a user to select a media asset, compares a language proficiency level required to comprehend the media asset and the language proficiency level of the user to determine whether to automatically provide translations, and selectively delivers an output comprising the translation. For example, the suitable application may be a web browser that allows a user to select a media asset for viewing (e.g., Chrome browser which allows users access to videos uploaded on social media platforms such as YouTube, etc.). In some embodiments, the suitable application may be an application configured to receive live and/or non-live content from an over-the-top (OTT) content provider (e.g., Netflix, Hulu, Amazon Prime, etc.). In some embodiments, the suitable application may be a media guidance application.

Specifically, the media guidance application determines a level of proficiency of a language required to comprehend the media content, a level of proficiency of the user in the language, and determines whether the level of proficiency of the language required to comprehend the media content is equal to, higher than, or lower than the level of proficiency of the user. In response to determining that the level of proficiency of the user is lower than the level of proficiency of the language required to comprehend the media content, the media guidance application requests a translation in a language native to the user; otherwise the media guidance application displays the media content without the translation. The translation may be included as part of the metadata corresponding to the media content. In some embodiments, the media guidance application may request the translation from a remote cloud server. The media guidance application receives the translation and provides it to the first device for output. Accordingly, the user is able to fully comprehend the media content without needing to navigate to the options menu each time they wish to watch media content in a non-native language.

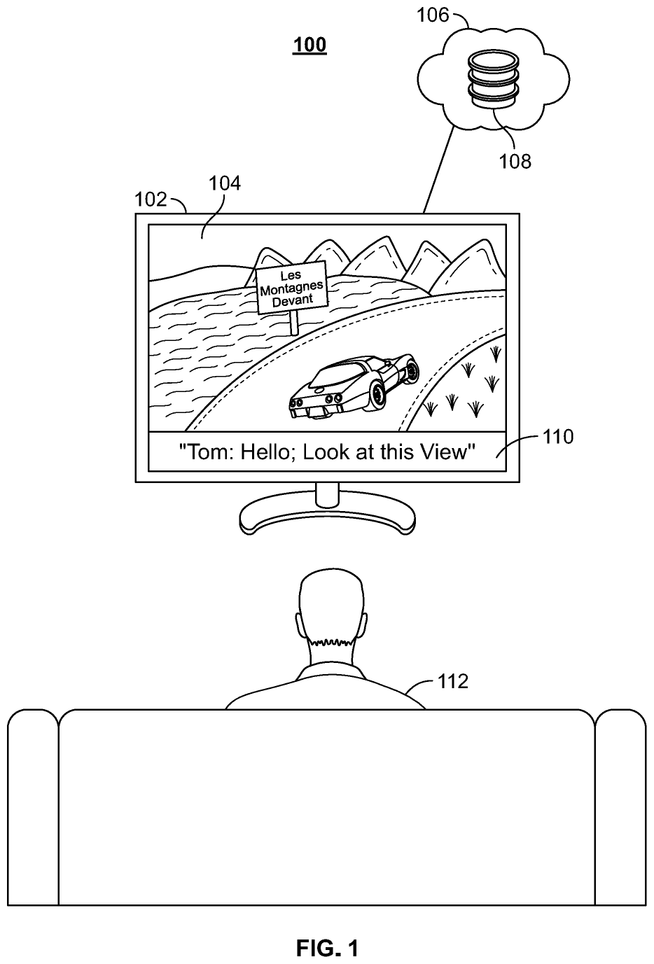

FIG. 1 shows an illustrative example of a first device 102 displaying a media asset 104 in a foreign language. In some embodiments, the media guidance application may determine (e.g., using control circuitry on the first device 102) a language spoken in a media asset 104 (e.g., based on metadata corresponding to the media asset). The media guidance application may also retrieve a profile of a user 112 viewing the media asset 104 stored on the first device 102 and/or a remote cloud server 106, and determine whether the language spoken in the media asset 104 is a language native to the user 112 (e.g., based on the user profile which may list the languages native to the user 112). The media guidance application may communicate with the remote cloud server 106 via a communications network. Communications network may be one or more networks including the Internet, a mobile phone network, mobile voice or data network (e.g., a 4G or LTE network), cable network, public switched telephone network, or an other type of communications network or combination of communications network.

The media guidance application may, in response to determining that the language is not native to the user 112, determine a level of proficiency of the language required to comprehend the media asset 104 (e.g., based on metadata corresponding to the media asset 104) and determine a level of proficiency of the user 112 corresponding to the language (e.g., based on the user profile). The media guidance application may determine (e.g., using control circuitry on the first device 102) whether the level of proficiency of the language required to comprehend the media asset 104 is equal to, higher than, or lower than the level of proficiency of the user 112 corresponding to the language. In response to determining that the level of proficiency of the user 112 is equal to or higher than the level of proficiency of the language required to comprehend the media asset 104, the media guidance application may generate an output comprising the media asset 104 at the first device 102. In response to determining that the level of proficiency of the user 112 is lower than the level of proficiency of the language required to comprehend the media asset 104, the media guidance application may request a translation 110 to a language native to the user 112 from a cloud server 106. In some embodiments, the media guidance application may determine that a language track in a language native to the user is included in the metadata corresponding to the media asset 104, and may retrieve the language track in the language native to the user as the translation 110. In response to receiving the translation 110 from the cloud server 108 and/or retrieving the translation 110 from the metadata corresponding to the media asset 104, the media guidance application may generate an output comprising the translation 110 at the first device 102.

As an example, a user 112 may decide to watch the French movie “Jour de fête.” The media guidance application may, using control circuitry and based on the metadata corresponding to the movie 104, determine that the primary language spoken in the movie 104 is French. In some embodiments, the metadata corresponding to the movie 104 may include the language spoken in the movie 104, and the media guidance application may, via the control circuitry based on the metadata, make the determination of the language spoken in the movie 104. In some embodiments, the media guidance application may determine the language spoken in the movie 104 based on a country of origin of the movie 104. For example, the media guidance application, based on the metadata corresponding to the movie 104, may determine that the movie 104 was created in France. In response to determining that the movie 104 originated in France, the media guidance application may determine that French is the national language spoken in France, and therefore, the language spoken in the movie 104 is likely French.

The media guidance application may access a profile for the user 112 viewing the movie 104. In some embodiments, the user profile may be stored in a database 108 on a cloud server 106. In some embodiments, the media guidance application may access a profile for the user 112 viewing the movie stored on a first device 102 on which the user 112 is viewing the movie 104. The media guidance application may, using the control circuitry, determine whether French is a language native to the user 112. For example, the user profile stored on the database 108 may include a list of languages native to the user 112. If the user 112 is a native speaker of French, the media guidance application determines that a translation 110 is not required for the user 112 to comprehend the movie 104. Therefore, the media guidance application may generate, for display, the movie 104 without a translation 110 on the first device 102.

In response to determining that French is not native to the user 112, the media guidance application, via control circuitry, may determine the level of proficiency in French that is required to comprehend the movie “Jour de fête” based on the metadata corresponding to the movie 104. For example, the user profile stored on the database 108 may indicate that the languages native to the user 112 are English and Spanish. In some embodiments, the media guidance application, using the control circuitry, may determine the required level of proficiency in the language by analyzing the words spoken in the media asset 104. For example, the media guidance application, based on the metadata using the control circuitry, may generate a list of most frequently used words and/or phrases in the movie 104. For example, the metadata may include a subtitle file that includes all the words spoken in the movie 104. In an example, the user 112 may wish to watch a foreign-language video uploaded on YouTube by another user, and the video metadata may not include a subtitle file corresponding to the video. In such a case, the media guidance application, via control circuitry, may transcribe the audio file to generate a corresponding text file. The media guidance application, via control circuitry, may assign each of the most frequently used words and/or phrases into one of a plurality of groups corresponding to various proficiency levels required to comprehend the words and/or phrases in the language. For example, the media guidance application may group the list of most frequently used words and/or phrases into five groups: (1) Native Speaker; (2) Very Good Command; (3) Working Knowledge; (4) Beginner; and (5) Non-Speaker, based on the proficiency levels required to comprehend the words and/or phrases in the language. In some embodiments, the metadata corresponding to the movie 104 may include an indication of the level of proficiency of the language required to comprehend the movie 104. The media guidance application, via control circuitry, may determine the level of proficiency of the language required to comprehend the movie based on the metadata corresponding to the movie 104. It will be evident to a person possessing ordinary skill in the art that any number of groups may be chosen to provide additional granularity in determining the level of proficiency of the language required to comprehend the media asset.

Moreover, the media guidance application, via control circuitry, may determine a level of proficiency of the user 112 corresponding to the language. For example, the media guidance application, via control circuitry, may determine the level of proficiency of the user 112 in French if the user 112 wishes to watch the movie “Jour de fête,” and the user 112 is not a native French speaker. In some embodiments, the media guidance application, via control circuitry, may generate a prompt requesting the user 112 to input a level of proficiency of the user 112 corresponding to the language. For example, the media guidance application, via control circuitry, may generate a prompt on the first device 102 that requests the user 112 to select one of five user-selectable options: (1) Native Speaker; (2) Very Good Command; (3) Working Knowledge; (4) Beginner; and (5) Non-Speaker. For example, the user 112 may select the user-selectable option (3) Working Knowledge in response to the prompt. It will be evident to a person possessing ordinary skill in the art that any number of groups may be chosen to provide additional granularity in determining the level of proficiency of the user corresponding to the language. In response to receiving the user input, the media guidance application, via control circuitry, may store the user selection as the level of proficiency of the user 112 corresponding to the language in the user profile on a database 108 stored in a remote cloud server 106 and/or the first device 102.

In some embodiments, the media guidance application, via control circuitry, may determine the level of proficiency of the user 112 corresponding to the language based on the information stored in the user profile stored in the database 108 on the cloud server 106. In some embodiments, the media guidance application, via control circuitry, may determine the level of proficiency of the user 112 corresponding to the language based on online activity of the user 112. For example, the user profile information stored in the database 108 may include browsing history of the user 112. The media guidance application, via control circuitry, may correlate a total number of hours spent on websites in the foreign language with a corresponding proficiency level. For example, if the user 112 has spent more than 20 hours in a week browsing websites that have content in French, the media guidance application may classify the user 112 as being a native speaker of French. If the user 112 has spent more than 10 hours but less than 20 hours in a week browsing websites that have content in French, the media guidance application may classify the user 112 as having a very good command of French. If the user 112 has spent more than 5 hours but less than 10 hours in a week browsing websites that have content in French, the media guidance application may classify the user 112 as having a working knowledge of French. If the user 112 has spent more than an hour but less than 5 hours in a week browsing websites that have content in French, the media guidance application may classify the user 112 as being a beginner in learning French. If the user 112 has browsed websites with content in French only on occasion, the media guidance application may classify the user 112 as a non-speaker of French.

In some embodiments, the media guidance application, via control circuitry, may determine the level of proficiency of the user 112 corresponding to the language based on a media asset viewing history of the user 112. For example, the user profile information stored in the database 108 may include a total number of hours spent viewing a media asset in the language within a predetermined amount of time. The media guidance application, via control circuitry, may correlate a total number of hours spent viewing media assets in the foreign language with a corresponding proficiency level. For example, if the user 112 has spent more than 20 hours in a week viewing media assets that have content in French, the media guidance application may classify the user 112 as being a native speaker of French. If the user 112 has spent more than 10 hours but less than 20 hours in a week viewing media assets that have content in French, the media guidance application may classify the user 112 as having a very good command of French. If the user 112 has spent more than 5 hours but less than 10 hours in a week viewing media assets that have content in French, the media guidance application may classify the user 112 as having a working knowledge of French. If the user 112 has spent more than an hour but less than 5 hours in a week viewing media assets that have content in French, the media guidance application may classify the user 112 as being a beginner in learning French. If the user 112 has viewed media assets with content in French only on occasion, the media guidance application may classify the user 112 as a non-speaker of French.

In some embodiments, the media guidance application, via control circuitry, may determine the level of proficiency of the user 112 corresponding to the language based on a music selection history of the user 112. For example, the user profile information stored in the database 108 may include a total number of hours spent listening to music in the language within a predetermined amount of time. The media guidance application, via control circuitry, may correlate a total number of hours spent listening to musical assets that are in the foreign language with a corresponding proficiency level. For example, if the user 112 has spent more than 20 hours in a week listening to musical assets that are in French, the media guidance application may classify the user 112 as being a native speaker of French. If the user 112 has spent more than 10 hours but less than 20 hours in a week listening to musical assets that are in French, the media guidance application may classify the user 112 as having a very good command of French. If the user 112 has spent more than 5 hours but less than 10 hours in a week listening to musical assets that are in French, the media guidance application may classify the user 112 as having a working knowledge of French. If the user 112 has spent more than an hour but less than 5 hours in a week listening to musical assets that are in French, the media guidance application may classify the user 112 as being a beginner in learning French. If the user 112 has listened to musical assets that are in French only on occasion, the media guidance application may classify the user 112 as a non-speaker of French.

In some embodiments, the media guidance application, via control circuitry, may determine the level of proficiency of the user 112 corresponding to the language based on an amount of time spent reading a text item written in the language. For example, the user profile information stored in the database 108 may include a total number of hours spent reading a text item written in the language within a predetermined amount of time. The media guidance application, via control circuitry, may correlate a total number of hours spent reading a text item written in the foreign language with a corresponding proficiency level. For example, if the user 112 has spent more than 20 hours in a week reading a text item written in French, the media guidance application may classify the user 112 as being a native speaker of French. If the user 112 has spent more than 10 hours but less than 20 hours in a week reading a text item written in French, the media guidance application may classify the user 112 as having a very good command of French. If the user 112 has spent more than 5 hours but less than 10 hours in a week reading a text item written in French, the media guidance application may classify the user 112 as having a working knowledge of French. If the user 112 has spent more than an hour but less than 5 hours in a week reading a text item written in French, the media guidance application may classify the user 112 as being a beginner in learning French. If the user 112 has read a text item written in French only on occasion, the media guidance application may classify the user 112 as a non-speaker of French.

In some embodiments, the media guidance application, via control circuitry, may determine the level of proficiency of the user 112 corresponding to the language based on an amount of time spent creating a text item written in the language. For example, the user profile information stored in the database 108 may include a total number of hours spent creating a text item written in the language within a predetermined amount of time. The media guidance application, via control circuitry, may correlate a total number of hours spent creating a text item written in the foreign language with a corresponding proficiency level. For example, if the user 112 has spent more than 20 hours in a week creating a text item written in French, the media guidance application may classify the user 112 as being a native speaker of French. If the user 112 has spent more than 10 hours but less than 20 hours in a week creating a text item written in French, the media guidance application may classify the user 112 as having a very good command of French. If the user 112 has spent more than 5 hours but less than 10 hours in a week creating a text item written in French, the media guidance application may classify the user 112 as having a working knowledge of French. If the user 112 has spent more than an hour but less than 5 hours in a week creating a text item written in French, the media guidance application may classify the user 112 as being a beginner in learning French. If the user 112 has created a text item written in French only on occasion, the media guidance application may classify the user 112 as a non-speaker of French.

In some embodiments, the media guidance application, via control circuitry, may determine the level of proficiency of the user 112 corresponding to the language based on an amount of time spent editing a text item written in the language. For example, the user profile information stored in the database 108 may include a total number of hours spent editing a text item written in the language within a predetermined amount of time. The media guidance application, via control circuitry, may correlate a total number of hours spent editing a text item written in the foreign language with a corresponding proficiency level. For example, if the user 112 has spent more than 20 hours in a week editing a text item written in French, the media guidance application may classify the user 112 as being a native speaker of French. If the user 112 has spent more than 10 hours but less than 20 hours in a week editing a text item written in French, the media guidance application may classify the user 112 as having a very good command of French. If the user 112 has spent more than 5 hours but less than 10 hours in a week editing a text item written in French, the media guidance application may classify the user 112 as having a working knowledge of French. If the user 112 has spent more than an hour but less than 5 hours in a week editing a text item written in French, the media guidance application may classify the user 112 as being a beginner in learning French. If the user 112 has edited a text item written in French only on occasion, the media guidance application may classify the user 112 as a non-speaker of French.

In some embodiments, the media guidance application, via control circuitry, may determine the level of proficiency of the user 112 corresponding to the language based on previous requests for subtitles submitted by the user 112. For example, the user profile information stored in the database 108 may include an indication of how often the user 108 has requested subtitles when viewing a media asset in the language within a predetermined amount of time. The media guidance application, via control circuitry, may correlate a total number of times the user 112 requested subtitles in the foreign language with a corresponding proficiency level. For example, if the user 112 has requested subtitles when viewing content in French less than 25% of the time, the media guidance application may classify the user 112 as being a native speaker of French. If the user 112 has requested subtitles when viewing content in French less than 50% but more than 25%, the media guidance application may classify the user 112 as having a very good command of French. If the user 112 has requested subtitles when viewing content in French less than 75% but more than 50%, the media guidance application may classify the user 112 as having a working knowledge of French. If the user 112 has requested subtitles when viewing content in French less than 100% but more than 75%, the media guidance application may classify the user 112 as being a beginner in learning French. If the user 112 has always requested subtitles when viewing a media asset in French, the media guidance application may classify the user 112 as a non-speaker of French.

It will be evident to a person possessing ordinary skill in the art that the ranges provided above are merely examples, and that any suitable time period may be chosen over which to monitor a user's online activity, a media asset viewing history, a music selection history, text item reading history, text item creating history, and text item editing history for a particular language, and that various suitable thresholds may be selected for determining the level of proficiency of the user corresponding to the language.

The media guidance application, via control circuitry, may determine whether the level of proficiency of the language required to comprehend the media asset 104 is equal to, higher than, or lower than the level of proficiency of the user 112. For example, the media guidance application may determine whether the level of proficiency of French required to comprehend the movie “Jour de fête” is equal to, higher than, or lower than the level of proficiency of the user 112 in French. In response to determining that the level of proficiency of the user 112 is equal to or higher than the level of proficiency of the language required to comprehend the media asset 104, the media guidance application, via control circuitry, may generate an output comprising the media asset 104. For example, in response to determining that the level of proficiency of the user 112 in French is equal to or higher than the level of proficiency of French required to comprehend the movie “Jour de fête,” the media guidance application, via control circuitry, may generate for display at the first device 102, the movie 104 to be viewed by the user 112 without a translation 110. In some embodiments, the movie 104 includes a video file and an audio file corresponding to the video file. The media guidance application, via control circuitry, streams both the video file and the audio file to the first device 102 accessible by the user 112, and generates, for display on the first device 102, the movie 104.

In response to determining that the level of proficiency of the user 112 is lower than the level of proficiency of the language required to comprehend the media asset 104, the media guidance application, via control circuitry, may request a translation 110 to a language native to the user 112 from the cloud server 106 and/or retrieve a language track in a language native to the user 112 from metadata corresponding to the media asset 104. For example, in response to determining that the level of proficiency of the user 112 in French is lower than the level of proficiency of French required to comprehend the movie “Jour de fête,” the media guidance application, via control circuitry, may request a translation from a cloud server 106 in a language native to the user 112 corresponding to the movie 104 (e.g., English or Spanish). In some embodiments, the translation 110 may comprise a subtitle track, closed-captioning track, and/or an audio recording in the native language. For example, the translation 110 may include an audio translation of the movie in English or Spanish. In another example, the translation 110 may include a subtitle file which includes an English or Spanish translation of the movie 104. In some embodiments, the metadata corresponding to the media asset 104 may include one or more language tracks corresponding to audio translations of the media asset in a plurality of languages. In some embodiments, the media guidance application may retrieve a language track comprising an audio translation of the media asset 104 in a language native to the user 112 from the metadata corresponding to the media asset 104. For example, the media guidance application, implemented on control circuitry, may retrieve an English or Spanish language translation from the metadata corresponding to the movie “Jour de fête.”

In response to receiving the translation from the cloud server 106, the media guidance application, via control circuitry, may generate for display an output comprising the translation 110. For example, the media guidance application, via control circuitry, may generate for display at the first device 102 the video file of the movie 104 along with the translation 110 received from the cloud server 106. In some embodiments, the media guidance application, via control circuitry, may generate a display comprising a visual representation of the audio file synchronized with the video file in addition to streaming the audio file and the video file corresponding to the media asset 104. For example, the media guidance application, via control circuitry, may generate for display at the first device 102 a subtitle file 110 displayed in synchronization with the audio file and the video file of the movie “Jour de fête.”

In some embodiments, the media guidance application, via control circuitry, may replace the audio file corresponding to the media asset 104 with a second audio file, where the second audio file is a translation of the audio file of the media asset 104 in a language native to the user 112. For example, the media guidance application may replace the audio file corresponding to the movie “Jour de fête” with the second audio file comprising an English or Spanish translation of the audio file corresponding to the movie 104. In some embodiments, the media guidance application, via control circuitry, may stream the video file corresponding to the media asset 104 along with the second audio file to be displayed at the first device 102. For example, the media guidance application may generate, for display at the first device 102, the video file 104 corresponding to the movie “Jour de fête” along with an English or Spanish translation 110 dubbed over the original audio file.

By the media guidance application automatically determining whether the level of proficiency of the language required to comprehend the media asset 104 is equal to, higher than, or lower than the level of proficiency of the user 112, and responsive to the determination, providing an appropriate output to the user 112 (with a translation 110 when the level of proficiency of the language required to comprehend the media asset 104 is higher than the level of proficiency of the user 112; otherwise without the translation 110), the user 112 is spared the inconvenience of having to manually request or remove subtitles for each media content viewing. The user viewing experience is therefore improved. It will be evident to a person possessing skill in the art that the media guidance application may be replaced by any suitable application that allows a user 112 to select a media asset 104, compare a language proficiency level required to comprehend the media asset 104 and the language proficiency level of the user 112 to determine whether to automatically provide translations, and selectively deliver an output comprising the translation 110 based on the comparison result.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), on-demand information, blogs, websites, and any other type of guidance data that is helpful for a user to navigate among and locate desired content selections. In some embodiments, the media guidance data may include language information about the content, and may additionally include one or more language tracks corresponding to a translation of the original content in a plurality of languages.

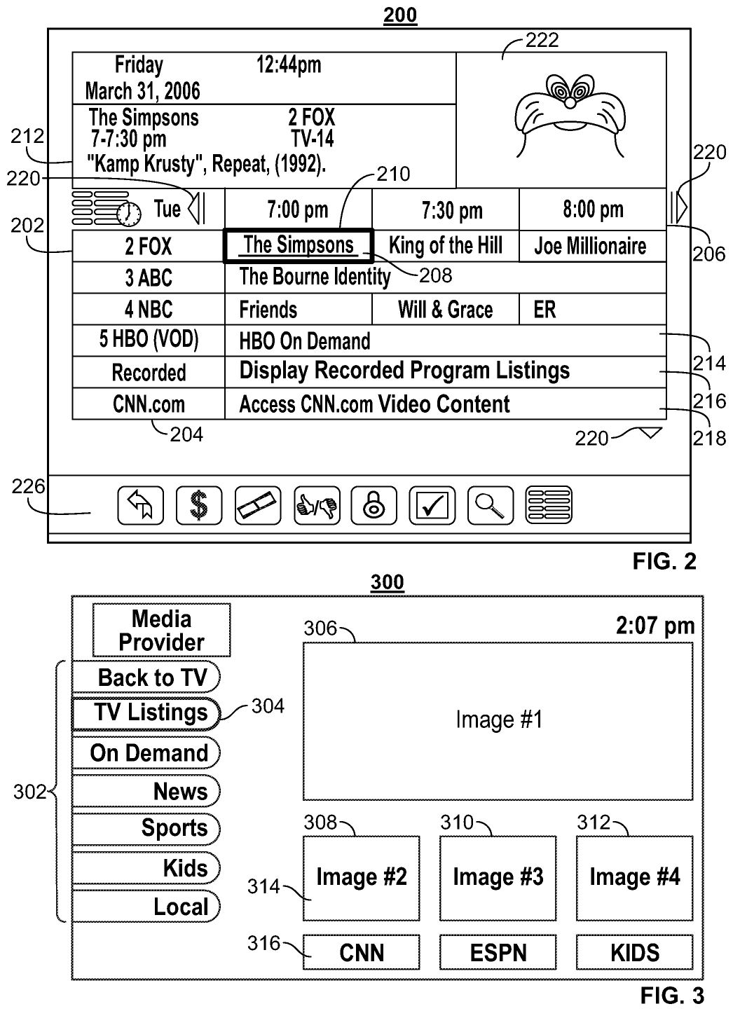

FIGS. 2-3 show illustrative display screens that may be used to provide media guidance data. The display screens shown in FIGS. 2-3 may be implemented on any suitable user equipment device or platform. While the displays of FIGS. 2-3 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 2 shows illustrative grid of a program listings display 200 arranged by time and channel that also enables access to different types of content in a single display. Display 200 may include grid 202 with: (1) a column of channel/content type identifiers 204, where each channel/content type identifier (which is a cell in the column) identifies a different channel or content type available; and (2) a row of time identifiers 206, where each time identifier (which is a cell in the row) identifies a time block of programming. Grid 202 also includes cells of program listings, such as program listing 208, where each listing provides the title of the program provided on the listing's associated channel and time. With a user input device, a user can select program listings by moving highlight region 210. Information relating to the program listing selected by highlight region 210 may be provided in program information region 212. Region 212 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 202 may provide media guidance data for non-linear programming including on-demand listing 214, recorded content listing 216, and Internet content listing 218. A display combining media guidance data for content from different types of content sources is sometimes referred to as a “mixed-media” display. Various permutations of the types of media guidance data that may be displayed that are different than display 200 may be based on user selection or guidance application definition (e.g., a display of only recorded and broadcast listings, only on-demand and broadcast listings, etc.). As illustrated, listings 214, 216, and 218 are shown as spanning the entire time block displayed in grid 202 to indicate that selection of these listings may provide access to a display dedicated to on-demand listings, recorded listings, or Internet listings, respectively. In some embodiments, listings for these content types may be included directly in grid 202. Additional media guidance data may be displayed in response to the user selecting one of the navigational icons 220. (Pressing an arrow key on a user input device may affect the display in a similar manner as selecting navigational icons 220.)

Display 200 may also include video region 222, and options region 226. Video region 222 may allow the user to view and/or preview programs that are currently available, will be available, or were available to the user. The content of video region 222 may correspond to, or be independent from, one of the listings displayed in grid 202. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Options region 226 may allow the user to access different types of content, media guidance application displays, and/or media guidance application features. Options region 226 may be part of display 200 (and other display screens described herein), or may be invoked by a user by selecting an on-screen option or pressing a dedicated or assignable button on a user input device. The selectable options within options region 226 may concern features related to program listings in grid 202 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. For example, the user profile may include information about a level of proficiency of the user corresponding to a language. In some embodiments, the user profile may include a list of languages native to the user. Additionally, the media guidance application may obtain all or part of other user profiles that are related to a particular user (e.g., from other web sites on the Internet the user accesses, such as www.Tivo.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 5. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 3. Video mosaic display 300 includes selectable options 302 for content information organized based on content type, genre, and/or other organization criteria. In display 300, television listings option 304 is selected, thus providing listings 306,308,310, and 312 as broadcast program listings. In display 300 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 308 may include more than one portion, including media portion 314 and text portion 316. Media portion 314 and/or text portion 316 may be selectable to view content in full-screen or to view information related to the content displayed in media portion 314 (e.g., to view listings for the channel that the video is displayed on).

The listings in display 300 are of different sizes (i.e., listing 306 is larger than listings 308,310, and 312), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

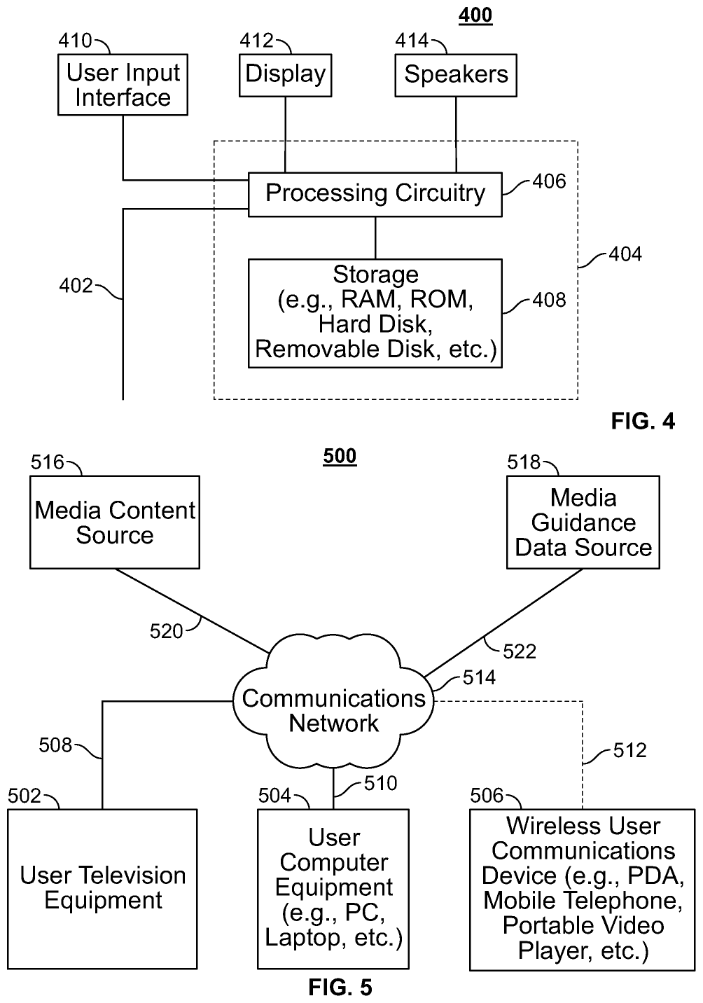

Users may access content and the media guidance application (and its display screens described above and below) from one or more of their user equipment devices. FIG. 4 shows a generalized embodiment of illustrative user equipment device 400. More specific implementations of user equipment devices are discussed below in connection with FIG. 5. User equipment device 400 may receive content and data via input/output (hereinafter “I/O”) path 402. I/O path 402 may provide content (e.g., broadcast programming, on-demand programming, Internet content, content available over a local area network (LAN) or wide area network (WAN), and/or other content) and data to control circuitry 404, which includes processing circuitry 406 and storage 408. Control circuitry 404 may be used to send and receive commands, requests, and other suitable data using I/O path 402. I/O path 402 may connect control circuitry 404 (and specifically processing circuitry 406) to one or more communications paths (described below). I/O functions may be provided by one or more of these communications paths, but are shown as a single path in FIG. 4 to avoid overcomplicating the drawing.

Control circuitry 404 may be based on any suitable processing circuitry such as processing circuitry 406. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 404 executes instructions for a media guidance application stored in memory (i.e., storage 408). Specifically, control circuitry 404 may be instructed by the media guidance application to perform the functions discussed above and below. For example, the media guidance application may provide instructions to control circuitry 404 to generate the media guidance displays. In some implementations, any action performed by control circuitry 404 may be based on instructions received from the media guidance application.

In client-server based embodiments, control circuitry 404 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 5). In addition, communications circuitry may include circuitry that enables peer-to-peer communication of user equipment devices, or communication of user equipment devices in locations remote from each other (described in more detail below).

Memory may be an electronic storage device provided as storage 408 that is part of control circuitry 404. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 408 may be used to store various types of content described herein as well as media guidance data described above. Nonvolatile memory may also be used (e.g., to launch a boot-up routine and other instructions). Cloud-based storage, described in relation to FIG. 5, may be used to supplement storage 408 or instead of storage 408.

Control circuitry 404 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 404 may also include scaler circuitry for upconverting and downconverting content into the preferred output format of the user equipment 400. Circuitry 404 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 408 is provided as a separate device from user equipment 400, the tuning and encoding circuitry (including multiple tuners) may be associated with storage 408.

A user may send instructions to control circuitry 404 using user input interface 410. User input interface 410 may be any suitable user interface, such as a remote control, mouse, trackball, keypad, keyboard, touch screen, touchpad, stylus input, joystick, voice recognition interface, or other user input interfaces. Display 412 may be provided as a stand-alone device or integrated with other elements of user equipment device 400. For example, display 412 may be a touchscreen or touch-sensitive display. In such circumstances, user input interface 410 may be integrated with or combined with display 412. Display 412 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 412 may be HDTV-capable. In some embodiments, display 412 may be a 3D display, and the interactive media guidance application and any suitable content may be displayed in 3D. A video card or graphics card may generate the output to the display 412. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 404. The video card may be integrated with the control circuitry 404. Speakers 414 may be provided as integrated with other elements of user equipment device 400 or may be stand-alone units. The audio component of videos and other content displayed on display 412 may be played through speakers 414. In some embodiments, the audio may be distributed to a receiver (not shown), which processes and outputs the audio via speakers 414.

The guidance application may be implemented using any suitable architecture. For example, it may be a stand-alone application wholly-implemented on user equipment device 400. In such an approach, instructions of the application are stored locally (e.g., in storage 408), and data for use by the application is downloaded on a periodic basis (e.g., from an out-of-band feed, from an Internet resource, or using another suitable approach). Control circuitry 404 may retrieve instructions of the application from storage 408 and process the instructions to generate any of the displays discussed herein. Based on the processed instructions, control circuitry 404 may determine what action to perform when input is received from input interface 410. For example, movement of a cursor on a display up/down may be indicated by the processed instructions when input interface 410 indicates that an up/down button was selected.

In some embodiments, the media guidance application is a client-server based application. Data for use by a thick or thin client implemented on user equipment device 400 is retrieved on-demand by issuing requests to a server remote to the user equipment device 400. In one example of a client-server based guidance application, control circuitry 404 runs a web browser that interprets web pages provided by a remote server. For example, the remote server may store the instructions for the application in a storage device. The remote server may process the stored instructions using circuitry (e.g., control circuitry 404) and generate the displays discussed above and below. The client device may receive the displays generated by the remote server and may display the content of the displays locally on equipment device 400. This way, the processing of the instructions is performed remotely by the server while the resulting displays are provided locally on equipment device 400. Equipment device 400 may receive inputs from the user via input interface 410 and transmit those inputs to the remote server for processing and generating the corresponding displays. For example, equipment device 400 may transmit a communication to the remote server indicating that an up/down button was selected via input interface 410. The remote server may process instructions in accordance with that input and generate a display of the application corresponding to the input (e.g., a display that moves a cursor up/down). The generated display is then transmitted to equipment device 400 for presentation to the user.

In some embodiments, the media guidance application is downloaded and interpreted or otherwise run by an interpreter or virtual machine (run by control circuitry 404). In some embodiments, the guidance application may be encoded in the ETV Binary Interchange Format (EBIF), received by control circuitry 404 as part of a suitable feed, and interpreted by a user agent running on control circuitry 404. For example, the guidance application may be an EBIF application. In some embodiments, the guidance application may be defined by a series of JAVA-based files that are received and run by a local virtual machine or other suitable middleware executed by control circuitry 404. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 400 of FIG. 4 can be implemented in system 500 of FIG. 5 as user television equipment 502, user computer equipment 504, wireless user communications device 506, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 4 may not be classified solely as user television equipment 502, user computer equipment 504, or a wireless user communications device 506. For example, user television equipment 502 may, like some user computer equipment 504, be Internet-enabled allowing for access to Internet content, while user computer equipment 504 may, like some television equipment 502, include a tuner allowing for access to television programming. The media guidance application may have the same layout on various different types of user equipment or may be tailored to the display capabilities of the user equipment. For example, on user computer equipment 504, the guidance application may be provided as a web site accessed by a web browser. In another example, the guidance application may be scaled down for wireless user communications devices 506.

In system 500, there is typically more than one of each type of user equipment device but only one of each is shown in FIG. 5 to avoid overcomplicating the drawing. In addition, each user may utilize more than one type of user equipment device and also more than one of each type of user equipment device.

In some embodiments, a user equipment device (e.g., user television equipment 502, user computer equipment 504, wireless user communications device 506) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.Tivo.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 514. Namely, user television equipment 502, user computer equipment 504, and wireless user communications device 506 are coupled to communications network 514 via communications paths 508, 510, and 512, respectively. Communications network 514 may be one or more networks including the Internet, a mobile phone network, mobile voice or data network (e.g., a 4G or LTE network), cable network, public switched telephone network, or other types of communications network or combinations of communications networks. Paths 508, 510, and 512 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 512 is drawn with dotted lines to indicate that in the exemplary embodiment shown in FIG. 5 it is a wireless path and paths 508 and 510 are drawn as solid lines to indicate they are wired paths (although these paths may be wireless paths, if desired). Communications with the user equipment devices may be provided by one or more of these communications paths, but are shown as a single path in FIG. 5 to avoid overcomplicating the drawing.

Although communications paths are not drawn between user equipment devices, these devices may communicate directly with each other via communication paths, such as those described above in connection with paths 508, 510, and 512, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 514.

System 500 includes content source 516 and media guidance data source 518 coupled to communications network 514 via communication paths 520 and 522, respectively. Paths 520 and 522 may include any of the communication paths described above in connection with paths 508, 510, and 512. Communications with the content source 516 and media guidance data source 518 may be exchanged over one or more communications paths, but are shown as a single path in FIG. 5 to avoid overcomplicating the drawing. In addition, there may be more than one of each of content source 516 and media guidance data source 518, but only one of each is shown in FIG. 5 to avoid overcomplicating the drawing. (The different types of each of these sources are discussed below.) If desired, content source 516 and media guidance data source 518 may be integrated as one source device. Although communications between sources 516 and 518 with user equipment devices 502, 504, and 506 are shown as through communications network 514, in some embodiments, sources 516 and 518 may communicate directly with user equipment devices 502, 504, and 506 via communication paths (not shown) such as those described above in connection with paths 508, 510, and 512.

Content source 516 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 516 may be the originator of content (e.g., a television broadcaster, a Webcast provider, etc.) or may not be the originator of content (e.g., an on-demand content provider, an Internet provider of content of broadcast programs for downloading, etc.). Content source 516 may include cable sources, satellite providers, on-demand providers, Internet providers, over-the-top content providers, or other providers of content. Content source 516 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 518 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 518 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 518 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 518 may provide user equipment devices 502, 504, and 506 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 408, and executed by control circuitry 404 of a user equipment device 400. In some embodiments, media guidance applications may be client-server applications where only a client application resides on the user equipment device, and server application resides on a remote server. For example, media guidance applications may be implemented partially as a client application on control circuitry 404 of user equipment device 400 and partially on a remote server as a server application (e.g., media guidance data source 518) running on control circuitry of the remote server. When executed by control circuitry of the remote server (such as media guidance data source 518), the media guidance application may instruct the control circuitry to generate the guidance application displays and transmit the generated displays to the user equipment devices. The server application may instruct the control circuitry of the media guidance data source 518 to transmit data for storage on the user equipment. The client application may instruct control circuitry of the receiving user equipment to generate the guidance application displays.

Content and/or media guidance data delivered to user equipment devices 502, 504, and 506 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 500 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 5.

In one approach, user equipment devices may communicate with each other within a home network. User equipment devices can communicate with each other directly via short-range point-to-point communication schemes described above, via indirect paths through a hub or other similar device provided on a home network, or via communications network 514. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 516 to access content. Specifically, within a home, users of user television equipment 502 and user computer equipment 504 may access the media guidance application to navigate among and locate desirable content. Users may also access the media guidance application outside of the home using wireless user communications devices 506 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 514. These cloud resources may include one or more content sources 516 and one or more media guidance data sources 518. In addition or in the alternative, the remote computing sites may include other user equipment devices, such as user television equipment 502, user computer equipment 504, and wireless user communications device 506. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 504 or wireless user communications device 506 having content capture feature. Alternatively, the user can first transfer the content to a user equipment device, such as user computer equipment 504. The user equipment device storing the content uploads the content to the cloud using a data transmission service on communications network 514. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 4.

As referred herein, the term “in response to” refers to initiated as a result of. For example, a first action being performed in response to a second action may include interstitial steps between the first action and the second action. As referred herein, the term “directly in response to” refers to caused by. For example, a first action being performed directly in response to a second action may not include interstitial steps between the first action and the second action.

As referred herein, a “first device” is a device that may directly share multiple resources with the media guidance application. For example, a first device may be a set-top box, phone, tablet, computer, etc., running the media guidance application having a shared memory, processor, or display.

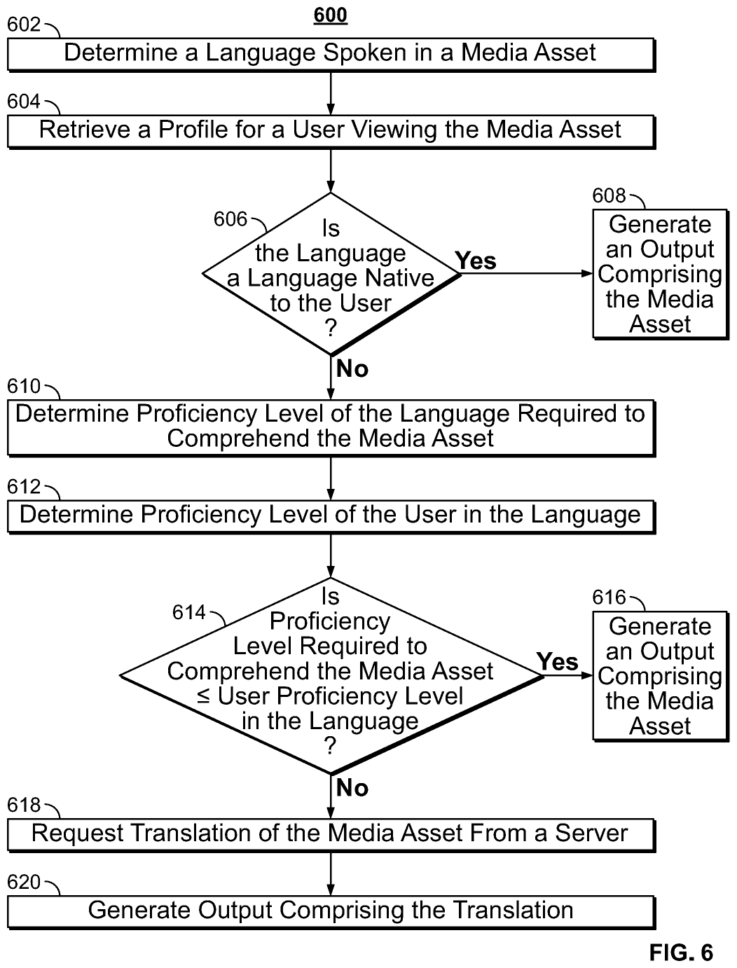

FIG. 6 is a flowchart of illustrative actions for a suitable application, implemented on control circuitry 404, to provide an output comprising a translation at a first device 102 when the user wishes to see a media asset in accordance with some embodiments of the disclosure. For example, the suitable application may be a web browser that allows the user to select a media asset for viewing (e.g., Chrome browser, which allows users access to videos uploaded on social media platforms such as YouTube, etc.). In some embodiments, the suitable application may be an application configured to receive live and/or non-live content from an over-the-top (OTT) content provider (e.g., Netflix®, Hulu®, Amazon Prime®, etc.). In some embodiments, the suitable application may be a media guidance application. A user may select a media asset to view from the grid 202 of a program listing display 200, or select a media asset to view from an over-the-top (OTT) content provider (e.g., Netflix®), or select a media asset from a web browser (e.g., select a video clip posted on YouTube®).

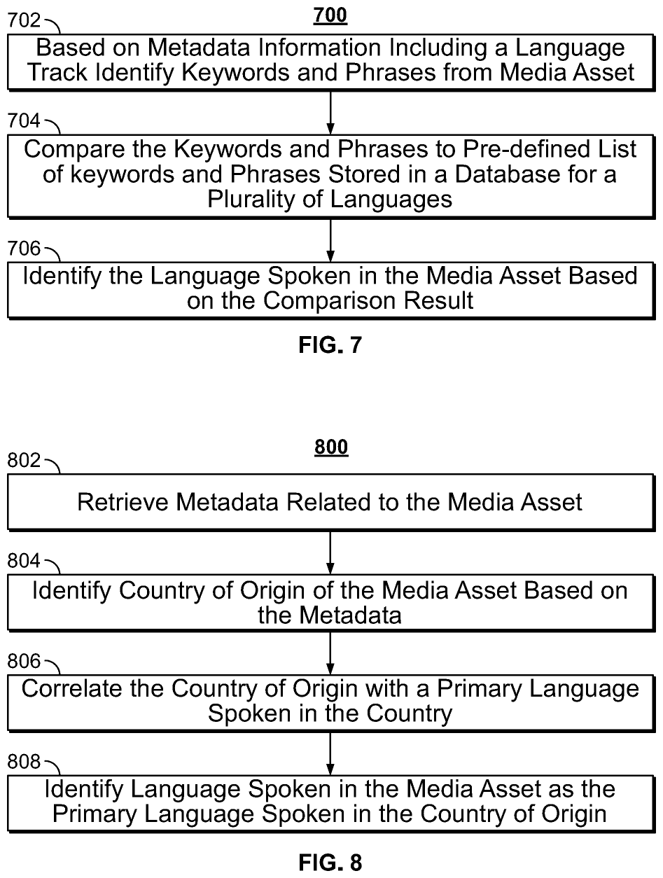

At 602, when the user selects a media asset to view on the first device, the media guidance application, implemented on control circuitry 404, determines a language spoken in a media asset. For example, the media guidance application may determine a language spoken in a movie 104 that the user 112 wishes to see on a first device 102. In some embodiments, the media guidance application, via control circuitry 404, may read and interpret metadata information corresponding to the media asset 104 to determine the language spoken in the media asset 104. For example, the media guidance application, via control circuitry 404, may read and interpret the metadata information to identify the language spoken in the movie to be French. In some embodiments, the language spoken in the media asset may be included in the guide data provided by the media guidance data source 518. Additional embodiments comprising systems and methods for determining a language spoken in a media asset are described in greater detail below with reference to FIGS. 7 and 8.

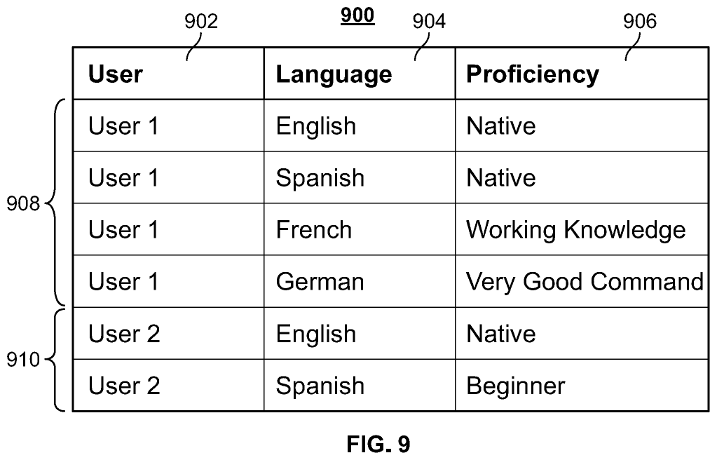

At 604, the media guidance application, implemented on control circuitry 404, retrieves a profile for a user viewing the media asset. For example, the media guidance application, via control circuitry 404, may retrieve a user profile (described in more detail below with reference to FIGS. 9-11) from a database 108 stored on a remote cloud server 106. In some embodiments, the user profile may be stored at a local memory (e.g., storage 408) of the first device 102.

At 606, the media guidance application, implemented on control circuitry 404, determines, based on the profile, whether the language is a language native to the user. For example, the media guidance application may, using the control circuitry, determine whether French is a language native to the user 112. In some embodiments, the user profile may include a list of languages native to the user. If the user 112 is a native speaker of French, the process moves to 608 and the media guidance application determines that a translation 110 is not required for the user 112 to comprehend the movie 104. In response to determining that the user 112 is not a native speaker of French, the process moves to 610. For example, the user profile may indicate that the user 112 is a native speaker of only English and Spanish.

At 608, in response to determining that the language is native to the user, the media guidance application, via control circuitry 404, generates an output comprising the media asset. For example, if the user 112 is a native speaker of French, the media guidance application may generate, for display, the movie 104 without a translation 110 on the first device 102.

At 610, in response to determining that the language is not native to the user, the media guidance application, implemented on control circuitry 404, determines a level of proficiency of the language required to comprehend the media asset. For example, in response to determining that French is not native to the user 112, the media guidance application, via control circuitry 404, may determine the level of proficiency in French that is required to comprehend the movie “Jour de fete” based on the metadata corresponding to the movie 104. In some embodiments, the media guidance application, using the control circuitry 404, may determine the level of proficiency in the language by analyzing the words spoken in the media asset 104. For example, the media guidance application, based on the metadata using the control circuitry, may generate a list of most frequently used words and/or phrases in the movie 104. For example, the metadata may include a subtitle file that includes all the words spoken in the movie 104. In an example, the user 112 may wish to watch a foreign-language video uploaded on YouTube by another user, and the video metadata may not include a subtitle file corresponding to the video. In such a case, the media guidance application, via control circuitry, may transcribe the audio file to generate a corresponding text file. The media guidance application, via control circuitry, may assign each of the most frequently used words and/or phrases into one of a plurality of groups corresponding to various proficiency levels required to comprehend the words and/or phrases in the language. For example, the media guidance application may group the list of most frequently used words and/or phrases into five groups: (1) Native Speaker; (2) Very Good Command; (3) Working Knowledge; (4) Beginner; and (5) Non-Speaker, based on the proficiency levels required to comprehend the words and/or phrases in the language. In some embodiments, the metadata corresponding to the movie 104 may include an indication of the level of proficiency of the language required to comprehend the movie 104. The media guidance application, via control circuitry, may determine the level of proficiency of the language required to comprehend the movie based on the metadata corresponding to the movie 104.

At 612, in response to determining that the language is not native to the user, the media guidance application, implemented on control circuitry 404, identifies, based on the profile, a level of proficiency of the user corresponding to the language. For example, the media guidance application, via control circuitry, may determine the level of proficiency of the user in French if the user wishes to watch the movie “Jour de fete,” and the user is not a native French speaker. In some embodiments, the media guidance application, via control circuitry, may generate a prompt requesting the user to input a level of proficiency of the user corresponding to the language. For example, the media guidance application, via control circuitry, may generate a prompt on the first device that requests the user to select one of five user-selectable options: (1) Native Speaker; (2) Very Good Command; (3) Working Knowledge; (4) Beginner; and (5) Non-Speaker. For example, the user may select the user-selectable option (3) Working Knowledge in response to the prompt. It will be evident to a person possessing ordinary skill in the art that any number of groups may be chosen to provide additional granularity in determining the level of proficiency of the user corresponding to the language. In response to receiving the user input, the media guidance application, via control circuitry, may store the user selection as the level of proficiency of the user corresponding to the language in the user profile on a database stored in a remote cloud server and/or the first device. In some embodiments, the media guidance application, implemented on control circuitry 404, may present a language fluency test to determine the level of proficiency of the user corresponding to the language. For example, the media guidance application, via control circuitry 404, may generate for display a test with user-selectable answers that test the user's proficiency levels in French.

In some embodiments, the media guidance application, via control circuitry, may determine the level of proficiency of the user corresponding to the language based on the information stored in the user profile. In some embodiments, the media guidance application, via control circuitry, may determine the level of proficiency of the user corresponding to the language based on online activity of the user. For example, the user profile information stored in the database may include browsing history of the user. The media guidance application, via control circuitry, may correlate a total number of hours spent on websites in the foreign language with a corresponding proficiency level. For example, if the user has spent more than 20 hours in a week browsing websites that have content in French, the media guidance application may classify the user as being a native speaker of French. If the user has spent more than 10 hours but less than 20 hours in a week browsing websites that have content in French, the media guidance application may classify the user as having a very good command of French. If the user has spent more than 5 hours but less than 10 hours in a week browsing websites that have content in French, the media guidance application may classify the user as having a working knowledge of French. If the user has spent more than an hour but less than 5 hours in a week browsing websites that have content in French, the media guidance application may classify the user as being a beginner in learning French. If the user has browsed websites with content in French only on occasion, the media guidance application may classify the user as a non-speaker of French.

In some embodiments, the media guidance application, via control circuitry, may determine the level of proficiency of the user corresponding to the language based on a media asset viewing history of the user. For example, the user profile information stored in the database may include a total number of hours spent viewing a media asset in the language within a predetermined amount of time. The media guidance application, via control circuitry, may correlate a total number of hours spent viewing media assets in the foreign language with a corresponding proficiency level. For example, if the user has spent more than 20 hours in a week viewing media assets that have content in French, the media guidance application may classify the user as being a native speaker of French. If the user has spent more than 10 hours but less than 20 hours in a week viewing media assets that have content in French, the media guidance application may classify the user as having a very good command of French. If the user has spent more than 5 hours but less than 10 hours in a week viewing media assets that have content in French, the media guidance application may classify the user as having a working knowledge of French. If the user has spent more than an hour but less than 5 hours in a week viewing media assets that have content in French, the media guidance application may classify the user as being a beginner in learning French. If the user has viewed media assets with content in French only on occasion, the media guidance application may classify the user as a non-speaker of French.

In some embodiments, the media guidance application, via control circuitry, may determine the level of proficiency of the user corresponding to the language based on a music selection history of the user. For example, the user profile information stored in the database may include a total number of hours spent listening to music in the language within a predetermined amount of time. The media guidance application, via control circuitry, may correlate a total number of hours spent listening to musical assets that are in the foreign language with a corresponding proficiency level. For example, if the user has spent more than 20 hours in a week listening to musical assets that are in French, the media guidance application may classify the user as being a native speaker of French. If the user has spent more than 10 hours but less than 20 hours in a week listening to musical assets that are in French, the media guidance application may classify the user as having a very good command of French. If the user has spent more than 5 hours but less than 10 hours in a week listening to musical assets that are in French, the media guidance application may classify the user as having a working knowledge of French. If the user has spent more than an hour but less than 5 hours in a week listening to musical assets that are in French, the media guidance application may classify the user as being a beginner in learning French. If the user has listened to musical assets that are in French only on occasion, the media guidance application may classify the user as a non-speaker of French.

In some embodiments, the media guidance application, via control circuitry, may determine the level of proficiency of the user corresponding to the language based on an amount of time spent reading a text item written in the language. For example, the user profile information stored in the database may include a total number of hours spent reading a text item written in the language within a predetermined amount of time. The media guidance application, via control circuitry, may correlate a total number of hours spent reading a text item written in the foreign language with a corresponding proficiency level. For example, if the user has spent more than 20 hours in a week reading a text item written in French, the media guidance application may classify the user as being a native speaker of French. If the user has spent more than 10 hours but less than 20 hours in a week reading a text item written in French, the media guidance application may classify the user as having a very good command of French. If the user has spent more than 5 hours but less than 10 hours in a week reading a text item written in French, the media guidance application may classify the user as having a working knowledge of French. If the user has spent more than an hour but less than 5 hours in a week reading a text item written in French, the media guidance application may classify the user as being a beginner in learning French. If the user has read a text item written in French only on occasion, the media guidance application may classify the user as a non-speaker of French.

In some embodiments, the media guidance application, via control circuitry, may determine the level of proficiency of the user corresponding to the language based on an amount of time spent creating a text item written in the language. For example, the user profile information stored in the database may include a total number of hours spent creating a text item written in the language within a predetermined amount of time. The media guidance application, via control circuitry, may correlate a total number of hours spent creating a text item written in the foreign language with a corresponding proficiency level. For example, if the user has spent more than 20 hours in a week creating a text item written in French, the media guidance application may classify the user as being a native speaker of French. If the user has spent more than 10 hours but less than 20 hours in a week creating a text item written in French, the media guidance application may classify the user as having a very good command of French. If the user has spent more than 5 hours but less than 10 hours in a week creating a text item written in French, the media guidance application may classify the user as having a working knowledge of French. If the user has spent more than an hour but less than 5 hours in a week creating a text item written in French, the media guidance application may classify the user as being a beginner in learning French. If the user has created a text item written in French only on occasion, the media guidance application may classify the user as a non-speaker of French.

In some embodiments, the media guidance application, via control circuitry, may determine the level of proficiency of the user corresponding to the language based on an amount of time spent editing a text item written in the language. For example, the user profile information stored in the database may include a total number of hours spent editing a text item written in the language within a predetermined amount of time. The media guidance application, via control circuitry, may correlate a total number of hours spent editing a text item written in the foreign language with a corresponding proficiency level. For example, if the user has spent more than 20 hours in a week editing a text item written in French, the media guidance application may classify the user as being a native speaker of French. If the user has spent more than 10 hours but less than 20 hours in a week editing a text item written in French, the media guidance application may classify the user as having a very good command of French. If the user has spent more than 5 hours but less than 10 hours in a week editing a text item written in French, the media guidance application may classify the user as having a working knowledge of French. If the user has spent more than an hour but less than 5 hours in a week editing a text item written in French, the media guidance application may classify the user as being a beginner in learning French. If the user has edited a text item written in French only on occasion, the media guidance application may classify the user as a non-speaker of French.

In some embodiments, the media guidance application, via control circuitry, may determine the level of proficiency of the user corresponding to the language based on previous requests for subtitles submitted by the user. For example, the user profile information stored in the database may include an indication of how often the user has requested subtitles when viewing a media asset in the language within a predetermined amount of time. The media guidance application, via control circuitry, may correlate a total number of times the user requested subtitles in the foreign language with a corresponding proficiency level. For example, if the user has requested subtitles when viewing content in French less than 25% of the time, the media guidance application may classify the user as being a native speaker of French. If the user has requested subtitles when viewing content in French less than 50% but more than 25%, the media guidance application may classify the user as having a very good command of French. If the user has requested subtitles when viewing content in French less than 75% but more than 50%, the media guidance application may classify the user as having a working knowledge of French. If the user has requested subtitles when viewing content in French less than 100% but more than 75%, the media guidance application may classify the user as being a beginner in learning French. If the user has always requested subtitles when viewing a media asset in French, the media guidance application may classify the user as a non-speaker of French.

At 614, the media guidance application, implemented on control circuitry 404, determines whether the level of proficiency of the language required to comprehend the media asset is equal to, higher than, or lower than the level of proficiency of the user. For example, the media guidance application may determine whether the level of proficiency of French required to comprehend the movie “Jour de fete,” is equal to, higher than, or lower than the level of proficiency of the user 112 in French.

At 616, in response to determining that the level of proficiency of the user 112 is equal to or higher than the level of proficiency of the language required to comprehend the media asset 104, the media guidance application, implemented on control circuitry 404, generates an output comprising the media asset 104. For example, in response to determining that the level of proficiency of the user 112 in French is equal to or higher than the level of proficiency of French required to comprehend the movie “Jour de fête,” the media guidance application, via control circuitry 404, may generate for display at the first device 102, the movie 104 to be viewed by the user 112 without a translation 110. In some embodiments, the movie 104 includes a video file and an audio file corresponding to the video file. The media guidance application, via control circuitry, streams both the video file and the audio file to the first device 102 accessible by the user 112, and generates, for display on the first device 102, the movie 104.

At 618, in response to determining that the level of proficiency of the user 112 is lower than the level of proficiency of the language required to comprehend the media asset 104, the media guidance application, implemented on control circuitry 404, requests a translation 110 to a language native to the user 112 from a remote cloud server 106. For example, in response to determining that the level of proficiency of the user 112 in French is lower than the level of proficiency of French required to comprehend the movie “Jour de fête,” the media guidance application, via control circuitry 404, may request a translation from a cloud server 106 in a language native to the user 112 corresponding to the movie 104 (e.g., English or Spanish). The cloud server 106 may receive the translation from, for example, the media guidance data source 518. In some embodiments, the translation 110 may be included in metadata corresponding to the media asset, and is retrieved by the cloud server and/or the media guidance application. In some embodiments, the translation 110 may comprise a subtitle track, closed-captioning track, and/or an audio recording in the native language. For example, the translation 110 may include an audio translation of the movie in English or Spanish. In another example, the translation 110 may include a subtitle file which includes an English or Spanish translation of the movie 104.

At 620, in response to receiving the translation from the cloud server 106, the media guidance application, implemented on control circuitry 404, generates for display an output comprising the translation. For example, the media guidance application, via control circuitry 404, may generate for display at the first device 102, the video file of the movie 104 along with the translation 110 received from the cloud server 106. In some embodiments, the media guidance application, via control circuitry, may generate a display comprising a visual representation of the audio file synchronized with the video file in addition to streaming the audio file and the video file corresponding to the media asset 104. For example, the media guidance application, via control circuitry, may generate for display at the first device 102, a subtitle file 110 displayed in synchronization with the audio file and the video file of the movie “Jour de fête.”

In some embodiments, the media guidance application, via control circuitry 404, may replace the audio file corresponding to the media asset 104 with a second audio file, where the second audio file is a translation of the audio file of the media asset 104 in a language native to the user 112. For example, the media guidance application may replace the audio file corresponding to the movie “Jour de fête” with the second audio file comprising an English or Spanish translation of the audio file corresponding to the movie 104. In some embodiments, the media guidance application, via control circuitry, may stream the video file corresponding to the media asset 104 along with the second audio file to be displayed at the first device 102. For example, the media guidance application may generate, for display at the first device 102, the video file 104 corresponding to the movie “Jour de fête” along with an English or Spanish translation 110 dubbed over the original audio file.

By the media guidance application automatically determining whether the level of proficiency of the language required to comprehend the media asset 104 is equal to, higher than, or lower than the level of proficiency of the user 112, and responsive to the determination, providing an appropriate output to the user 112 (with a translation 110 when the level of proficiency of the language required to comprehend the media asset 104 is higher than the level of proficiency of the user 112; otherwise without the translation 110), the user 112 is spared the inconvenience of having to manually request or remove subtitles for each media content viewing. The user viewing experience is therefore improved.

It will be evident to a person skilled in the art that the steps described above with reference to FIG. 6 could be performed by any other devices shown in FIGS. 4 and 5. For example, process 600 may be performed by control circuitry 404 as instructed by a media guidance application on user equipment 502, 504, 506, or first device 102, in order to play back media. In addition, one or more steps of any other process 600 may be incorporated into or combined with one or more steps of any other process or embodiment.

FIG. 7 is a flowchart of illustrative actions for a media guidance application, implemented on control circuitry 404, to determine a language spoken in a media asset, in accordance with some embodiments of the disclosure. At 702, the media guidance application, via control circuitry 404, reads and interprets metadata information corresponding to the media asset 104. For example, metadata information corresponding to the movie 104 may include a closed-captioning file which the media guidance application, implemented on control circuitry 404, may use to identify one or more keywords and phrases from the movie 104. For example, by analyzing a closed-captioning file included in metadata information corresponding to the movie “Jour de fête,” the media guidance application may identify keywords such as “oui,” “merci,” and “bonjour.”

At 704, the media guidance application, implemented on control circuitry 404, may determine whether the identified keywords and phrases are present in a predefined list of keywords and phrases stored in a database for a plurality of languages. For example, the cloud server 106 may include a database 108 that stores a plurality of keywords and phrases for a plurality of languages. The media guidance application, via control circuitry 404, may compare the identified keywords and phrases from the movie “Jour de fête,” against the predefined list of keywords and phrases stored in the database 108 on the cloud server 106.

At 706, the media guidance application, implemented on control circuitry 404, may identify the language spoken in the media asset based on the comparison result. For example, the media guidance application, via control circuitry 404, may determine that the keywords identified from the movie “Jour de fête,” (e.g., “oui,” “merci,” and “bonjour”) match the list of predefined keywords and phrases corresponding to French. The media guidance application therefore determines that the language spoken in the media asset is French. It will be evident to a person possessing ordinary skill in the art that many additional words or phrases may be used to develop the predefined list of keywords and phrases corresponding to the plurality of languages stored in the database 108 on the remote server 106.

In some embodiments, the metadata information included with the media asset may not include a closed-captioning file or the like. For example, videos uploaded on social media platforms such as Facebook® or YouTube® often do not include a closed-captioning file in their respective metadata information. The media guidance application, implemented on control circuitry 404, may transcribe an audio file corresponding to the media asset and perform the process discussed above in connection with FIG. 7.

It will be evident to a person skilled in the art that the steps described above with reference to FIG. 7 could be performed by any other devices shown in FIGS. 4 and 5. For example, process 700 may be performed by control circuitry 404 as instructed by a media guidance application on user equipment 502, 504, 506, or first device 102, in order to play back media. In addition, one or more steps of process 700 may be incorporated into or combined with one or more steps of any other process or embodiment (e.g., process 600).

FIG. 8 is a flowchart of illustrative actions for a media guidance application, implemented on control circuitry 404, to identify a language spoken in a media asset, in accordance with some embodiments of the disclosure. At 802, the media guidance application, via control circuitry 404, retrieves metadata information related to the media asset. For example, the media guidance application may retrieve metadata information corresponding to the movie “Jour de fête.” At 804, the media guidance application, implemented on control circuitry 404, may read and interpret metadata information corresponding to the media asset 104 to identify a country of origin. For example, metadata information corresponding to the movie 104 may include information regarding the country of origin for the movie “Jour de fête” which the media guidance application, implemented on control circuitry 404, may extract.

At 806, the media guidance application, implemented on control circuitry 404, may correlate the country of origin of the media asset with a primary language spoken in the country. For example, the media guidance application, via control circuitry 404, may determine that the movie “Jour de fête” originated in France based on the metadata information retrieved by the media guidance application. Moreover, the media guidance application, implemented on control circuitry 404, may correlate the country of origin of the media asset (e.g., France) with a primary language spoken in the country (e.g., French).

At 808, the media guidance application, implemented on control circuitry 404, may identify the language spoken in the media asset based on the correlation result. For example, the media guidance application, via control circuitry 404, may determine that the language spoken in the media asset is likely French because the media asset originated in France. It will be evident to a person possessing ordinary skill in the art that the media guidance application may use the metadata information to determine an origination location with more particularity to determine a specific dialect or accent based on the specific origination location in some embodiments.

It will be evident to a person skilled in the art that the steps described above with reference to FIG. 8 could be performed by any other devices shown in FIGS. 4 and 5. For example, process 800 may be performed by control circuitry 404 as instructed by a media guidance application on user equipment 502, 504, 506, or first device 102, in order to play back media. In addition, one or more steps of process 800 may be incorporated into or combined with one or more steps of any other process or embodiment (e.g., processes 600 and 700).

FIG. 9 shows an illustrative example of a user profile, in accordance with some embodiments of the disclosure. A database 108 stores a profile 900 for a plurality of users who may wish to view the media asset 104. The user profile 900 includes a plurality of columns including user identifier 902, languages 904, and a corresponding proficiency level of the user 906. As illustrated in FIG. 9, the user profile 900 includes a plurality of entries 908 corresponding to User 1. For instance, in the illustrated example, User 1 is a native speaker of English and Spanish and has a very good command of German and a working knowledge of French. Similarly, the profile 900 includes a plurality of entries 910 corresponding to User 2, which shows that User 2 is a native English speaker and is at beginner proficiency level for the Spanish language. In some embodiments, profile 900 may include a plurality of entries 908 and 910 for each user within a household.

In some embodiments, the media guidance application, implemented on control circuitry 404, may provide an output comprising the translation only to users in a household whose profile indicates that their level of proficiency corresponding to the language is lower than the level of proficiency required to comprehend the media asset. For example, in a case where User 1 and User 2 wish to watch a Spanish language program requiring a very good command level of proficiency to comprehend, the media guidance application, via control circuitry 404, may access the user profiles 900 and determine that User 1 would not want to receive an output comprising the translation, while User 2 would require an output comprising a translation to fully comprehend the Spanish language programming. In some embodiments, the media guidance application, via control circuitry, may generate for display an output comprising the translation on a secondary device associated with User 2. For example, the media guidance application, via control circuitry, may provide the translated audio file to User 2 on a tablet or phone such that User 2 can follow along with the Spanish language program and have an improved viewing experience.

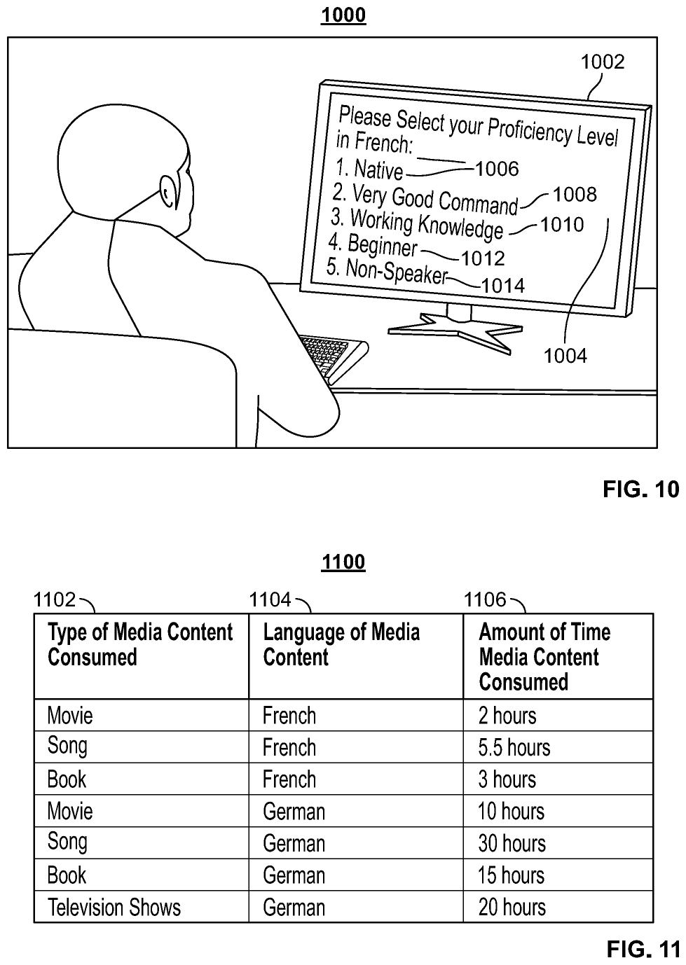

FIG. 10 shows an illustrative example of a media guidance system configuration for identifying a level of proficiency of the user corresponding to the language, in accordance with some embodiments of the disclosure. In some embodiments, the media guidance application, implemented via control circuitry 404, may generate a prompt for the user 112 on the first device 102 to input their level of proficiency corresponding to a language spoken in a media asset. For example, as illustrated in FIG. 10, a prompt 1004 may be generated on a display device 1002 providing the user a plurality of user-selectable options 1006, 1008, 1010, 1012, and 1014, each corresponding to a respective level of proficiency. A user 112 may select one of the following proficiency levels: Native (1006), Very Good Command (1008), Working Knowledge (1010), Beginner (1012), and Non-Speaker (1014). It will be evident to a person possessing ordinary skill in the art that fewer or additional user-selectable options may be provided to the user 112 to determine the level of proficiency of the user corresponding to the language with more or less particularity, as needed. In some embodiments, the media guidance application, implemented on control circuitry 404, may store the user selection in the database 108 storing the user profile.

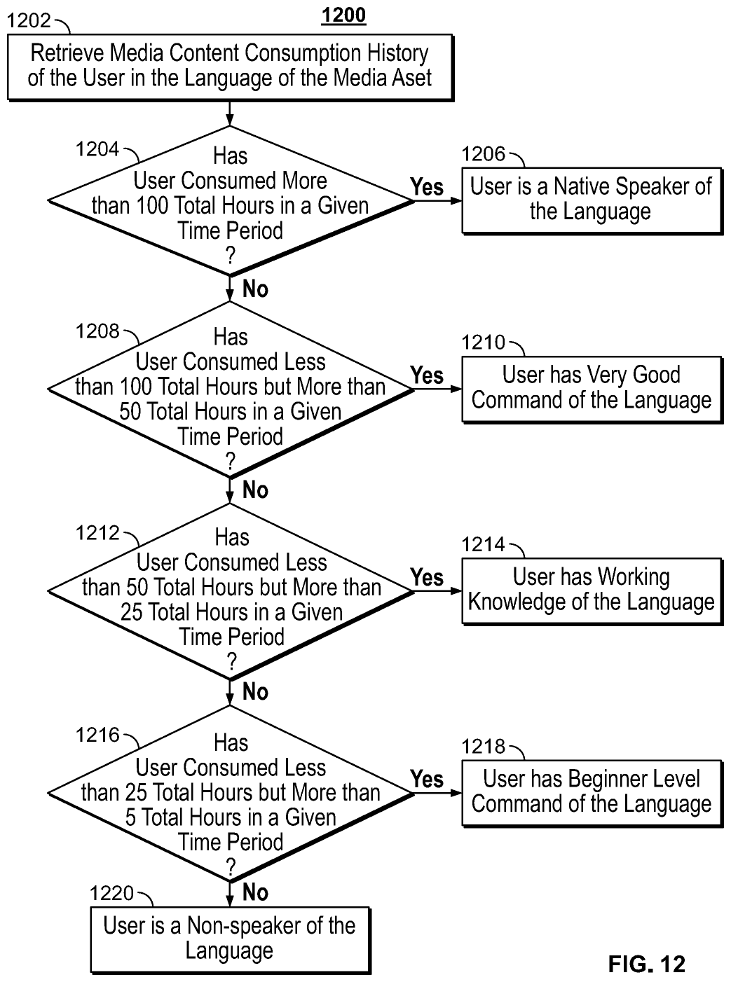

FIG. 11 shows an illustrative example of a user profile, in accordance with some embodiments of the disclosure. In some embodiments, the media guidance application may access a user profile 1100 stored on a database 108 stored in a cloud server 106. In some embodiments, the user profile 1100 may include a media consumption history for each user. For example, as illustrated in FIG. 11, the user profile 1100 may include information about a type of media content consumed 1102, a language of the media content 1104, and an amount of time the media content was consumed 1106. As discussed with reference to FIG. 12 below, the media guidance application, via control circuitry 404, may use the user profile information 1100 to determine a level of proficiency of the user corresponding to a language based on the type of media content consumed 1102, the language of the media content 1104, and the amount of time the media content was consumed 1106. For example, the user profile 1100 may indicate that the user has spent 2 hours watching a movie in French over the past week, whereas the user has spent 10 hours watching a movie in German. Based on the above, the media guidance application, via control circuitry 404, may conclude that user 112 is more proficient in German than in French.

FIG. 12 is a flowchart of illustrative actions for a media guidance application, implemented on control circuitry 404, to identify a level of proficiency of the user corresponding to a language, in accordance with some embodiments of the disclosure. At 1202, the media guidance application, implemented on control circuitry 404, retrieves a media content consumption history of the user of content that is in the language spoken in the media asset. For example, the media guidance application, via control circuitry 404, may retrieve the media content consumption history of the user 112 of media content that is in French when the user indicates a desire to watch the French movie “Jour de fête.” In some embodiments, the media content consumption history may include one or more of: online activity of the user, media asset viewing history of the user, music selection history of the user, amount of time spent reading a text item written in the language, amount of time spent creating a text item written in the language, and amount of time spent editing a text item written in the language. In some embodiments, the media content consumption history of the user 112 may be stored in the user profile stored in the database 108 on the remote server 106.

At 1204, the media guidance application, implemented on control circuitry 404, determines whether the user has consumed more than 100 hours of media content in the language spoken in the media asset within a given time period. For example, the media guidance application, implemented on control circuitry 404, may determine whether the user 112 has spent more than 100 hours consuming media content (e.g., watching movies, reading books, listening to music, etc.) in French. If the media guidance application determines that the user has spent more than 100 hours consuming media content in the language spoken in the media asset, the processing advances to Step 1206. At 1206, the media guidance application, implemented on control circuitry 404, determines that the user is a native speaker of the language spoken in the media asset. For example, the media guidance application, implemented on control circuitry 404, may determine that the user is a native French speaker.

If the media guidance application determines that the user has not spent more than 100 hours consuming media content in the language spoken in the media asset, the processing advances to Step 1208. At 1208, the media guidance application, implemented on control circuitry 404, determines whether the user has consumed more than 50 hours but less than 100 hours of media content in the language spoken in the media asset within a given time period. For example, the media guidance application, implemented on control circuitry 404, may determine whether the user 112 has spent more than 50 hours but less than 100 hours consuming media content (e.g., watching movies, reading books, listening to music, etc.) in French. If the media guidance application determines that the user has spent more than 50 hours but less than 100 hours consuming media content in the language spoken in the media asset, the processing advances to Step 1210. At 1210, the media guidance application, implemented on control circuitry 404, determines that the user has a very good command of the language spoken in the media asset. For example, the media guidance application, implemented on control circuitry 404, may determine that the user has a very good command of French.

If the media guidance application determines that the user has not spent more than 50 hours consuming media content in the language spoken in the media asset, the processing advances to Step 1212. At 1212, the media guidance application, implemented on control circuitry 404, determines whether the user has consumed more than 25 hours but less than 50 hours of media content in the language spoken in the media asset within a given time period. For example, the media guidance application, implemented on control circuitry 404, may determine whether the user 112 has spent more than 25 hours but less than 50 hours consuming media content (e.g., watching movies, reading books, listening to music, etc.) in French. If the media guidance application determines that the user has spent more than 25 hours but less than 50 hours consuming media content in the language spoken in the media asset, the processing advances to Step 1214. At 1214, the media guidance application, implemented on control circuitry 404, determines that the user has working knowledge of the language spoken in the media asset. For example, the media guidance application, implemented on control circuitry 404, may determine that the user has working knowledge of French.

If the media guidance application determines that the user has not spent more than 25 hours consuming media content in the language spoken in the media asset, the processing advances to Step 1216. At 1216, the media guidance application, implemented on control circuitry 404, determines whether the user has consumed more than 5 hours but less than 25 hours of media content in the language spoken in the media asset within a given time period. For example, the media guidance application, implemented on control circuitry 404, may determine whether the user 112 has spent more than 5 hours but less than 25 hours consuming media content (e.g., watching movies, reading books, listening to music, etc.) in French. If the media guidance application determines that the user has spent more than 5 hours but less than 25 hours consuming media content in the language spoken in the media asset, the processing advances to Step 1218. At 1218, the media guidance application, implemented on control circuitry 404, determines that the user has a beginner-level of proficiency of the language spoken in the media asset. For example, the media guidance application, implemented on control circuitry 404, may determine that the user has a beginner-level proficiency of French.

If the media guidance application determines that the user has not spent more than 5 hours consuming media content in the language spoken in the media asset, the processing advances to Step 1220. At 1220, the media guidance application, implemented on control circuitry 404, determines that the user is non-speaker of the language. For example, the media guidance application, implemented on control circuitry 404, may determine that the user is a non-speaker of French.

In some embodiments, the media guidance application, via control circuitry, may determine the level of proficiency of the user 112 corresponding to the language based on the information stored in the user profile stored in the database 108 on the cloud server 106. In some embodiments, the media guidance application, via control circuitry, may determine the level of proficiency of the user 112 corresponding to the language based on online activity of the user 112. For example, the user profile information stored in the database 108 may include browsing history of the user 112. The media guidance application, via control circuitry, may correlate a total number of hours spent on websites in the foreign language with a corresponding proficiency level. For example, if the user 112 has spent more than 20 hours in a week browsing websites that have content in French, the media guidance application may classify the user 112 as being a native speaker of French. If the user 112 has spent more than 10 hours but less than 20 hours in a week browsing websites that have content in French, the media guidance application may classify the user 112 as having a Very Good Command of French. If the user 112 has spent more than 5 hours but less than 10 hours in a week browsing websites that have content in French, the media guidance application may classify the user 112 as having a Working Knowledge of French. If the user 112 has spent more than an hour but less than 5 hours in a week browsing websites that have content in French, the media guidance application may classify the user 112 as being a Beginner in learning French. If the user 112 has browsed websites with content in French only on occasion, the media guidance application may classify the user 112 as a Non-Speaker of French.

In some embodiments, the media guidance application, via control circuitry, may determine the level of proficiency of the user 112 corresponding to the language based on a media asset viewing history of the user 112. For example, the user profile information stored in the database 108 may include a total number of hours spent viewing a media asset in the language within a predetermined amount of time. The media guidance application, via control circuitry, may correlate a total number of hours spent viewing media assets in the foreign language with a corresponding proficiency level. For example, if the user 112 has spent more than 20 hours in a week viewing media assets that have content in French, the media guidance application may classify the user 112 as being a Native Speaker of French. If the user 112 has spent more than 10 hours but less than 20 hours in a week viewing media assets that have content in French, the media guidance application may classify the user 112 as having a Very Good Command of French. If the user 112 has spent more than 5 hours but less than 10 hours in a week viewing media assets that have content in French, the media guidance application may classify the user 112 as having a working knowledge of French. If the user 112 has spent more than an hour but less than 5 hours in a week viewing media assets that have content in French, the media guidance application may classify the user 112 as being a beginner in learning French. If the user 112 has viewed media assets with content in French only on occasion, the media guidance application may classify the user 112 as a non-speaker of French.

In some embodiments, the media guidance application, via control circuitry, may determine the level of proficiency of the user 112 corresponding to the language based on a music selection history of the user 112. For example, the user profile information stored in the database 108 may include a total number of hours spent listening to music in the language within a predetermined amount of time. The media guidance application, via control circuitry, may correlate a total number of hours spent listening to musical assets that are in the foreign language with a corresponding proficiency level. For example, if the user 112 has spent more than 20 hours in a week listening to musical assets that are in French, the media guidance application may classify the user 112 as being a native speaker of French. If the user 112 has spent more than 10 hours but less than 20 hours in a week listening to musical assets that are in French, the media guidance application may classify the user 112 as having a very good command of French. If the user 112 has spent more than 5 hours but less than 10 hours in a week listening to musical assets that are in French, the media guidance application may classify the user 112 as having a working knowledge of French. If the user 112 has spent more than an hour but less than 5 hours in a week listening to musical assets that are in French, the media guidance application may classify the user 112 as being a beginner in learning French. If the user 112 has listened to musical assets that are in French only on occasion, the media guidance application may classify the user 112 as a non-speaker of French.

In some embodiments, the media guidance application, via control circuitry, may determine the level of proficiency of the user 112 corresponding to the language based on an amount of time spent reading a text item written in the language. For example, the user profile information stored in the database 108 may include a total number of hours spent reading a text item written in the language within a predetermined amount of time. The media guidance application, via control circuitry, may correlate a total number of hours spent reading a text item written in the foreign language with a corresponding proficiency level. For example, if the user 112 has spent more than 20 hours in a week reading a text item written in French, the media guidance application may classify the user 112 as being a native speaker of French. If the user 112 has spent more than 10 hours but less than 20 hours in a week reading a text item written in French, the media guidance application may classify the user 112 as having a very good command of French. If the user 112 has spent more than 5 hours but less than 10 hours in a week reading a text item written in French, the media guidance application may classify the user 112 as having a working knowledge of French. If the user 112 has spent more than an hour but less than 5 hours in a week reading a text item written in French, the media guidance application may classify the user 112 as being a beginner in learning French. If the user 112 has read a text item written in French only on occasion, the media guidance application may classify the user 112 as a non-speaker of French.

In some embodiments, the media guidance application, via control circuitry, may determine the level of proficiency of the user 112 corresponding to the language based on an amount of time spent creating a text item written in the language. For example, the user profile information stored in the database 108 may include a total number of hours spent creating a text item written in the language within a predetermined amount of time. The media guidance application, via control circuitry, may correlate a total number of hours spent creating a text item written in the foreign language with a corresponding proficiency level. For example, if the user 112 has spent more than 20 hours in a week creating a text item written in French, the media guidance application may classify the user 112 as being a native speaker of French. If the user 112 has spent more than 10 hours but less than 20 hours in a week creating a text item written in French, the media guidance application may classify the user 112 as having a very good command of French. If the user 112 has spent more than 5 hours but less than 10 hours in a week creating a text item written in French, the media guidance application may classify the user 112 as having a working knowledge of French. If the user 112 has spent more than an hour but less than 5 hours in a week creating a text item written in French, the media guidance application may classify the user 112 as being a beginner in learning French. If the user 112 has created a text item written in French only on occasion, the media guidance application may classify the user 112 as a non-speaker of French.

In some embodiments, the media guidance application, via control circuitry, may determine the level of proficiency of the user 112 corresponding to the language based on an amount of time spent editing a text item written in the language. For example, the user profile information stored in the database 108 may include a total number of hours spent editing a text item written in the language within a predetermined amount of time. The media guidance application, via control circuitry, may correlate a total number of hours spent editing a text item written in the foreign language with a corresponding proficiency level. For example, if the user 112 has spent more than 20 hours in a week editing a text item written in French, the media guidance application may classify the user 112 as being a native speaker of French. If the user 112 has spent more than 10 hours but less than 20 hours in a week editing a text item written in French, the media guidance application may classify the user 112 as having a very good command of French. If the user 112 has spent more than 5 hours but less than 10 hours in a week editing a text item written in French, the media guidance application may classify the user 112 as having a working knowledge of French. If the user 112 has spent more than an hour but less than 5 hours in a week editing a text item written in French, the media guidance application may classify the user 112 as being a beginner in learning French. If the user 112 has edited a text item written in French only on occasion, the media guidance application may classify the user 112 as a non-speaker of French.

It will be evident to a person possessing ordinary skill in the art that the ranges provided above are merely examples, and that any suitable time period may be chosen over which to monitor a user's online activity, media asset viewing history, music selection history, text item reading history, text item creating history, and text item editing history for a particular language, and that various suitable thresholds may be selected for determining the level of proficiency of the user corresponding to the language.

It will be evident to a person skilled in the art that the steps described above with reference to FIG. 12 could be performed by any other devices shown in FIGS. 4 and 5. For example, process 1200 may be performed by control circuitry 404 as instructed by a media guidance application on user equipment 502, 504, 506, or first device 102, in order to play back media. In addition, one or more steps of process 1200 may be incorporated into or combined with one or more steps of any other process or embodiment (e.g., processes 600, 700, and 800).

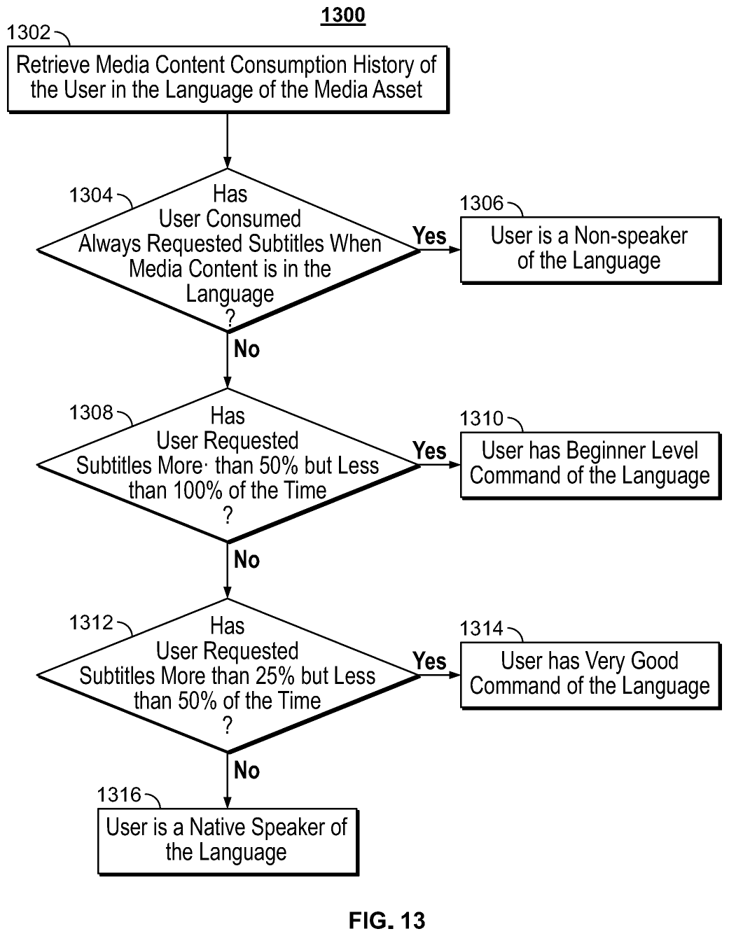

FIG. 13 is a flowchart of illustrative actions for a media guidance application, implemented on control circuitry 404, to identify a level of proficiency of the user corresponding to a language, in accordance with some embodiments of the disclosure. At 1302, the media guidance application, implemented on control circuitry 404, retrieves a media content consumption history of the user of content that is in the language spoken in the media asset. For example, the media guidance application, via control circuitry 404, may retrieve the media content consumption history of the user 112 of media content that is in French when the user indicates a desire to watch the French movie “Jour de fête.” In some embodiments, the media content consumption history may include a history of prior requests for subtitles made by the user. In some embodiments, the media content consumption history of the user 112 may be stored in the user profile stored in the database 108 on the remote server 106.

At 1304, the media guidance application, implemented on control circuitry 404, determines whether the user has always requested subtitles in the language spoken in the media asset within a given time period. For example, the media guidance application, implemented on control circuitry 404, may determine whether the user 112 has always requested subtitles when consuming media content (e.g., watching movies, television shows, video clips on YouTube®, etc.) in French. If the media guidance application determines that the user has always requested consuming media content in the language spoken in the media asset, the processing advances to Step 1306. At 1306, the media guidance application, implemented on control circuitry 404, determines that the user is a non-speaker of the language spoken in the media asset. For example, the media guidance application, implemented on control circuitry 404, may determine that the user is a non-French speaker.

If the media guidance application determines that the user has not always requested subtitles when consuming media content in the language spoken in the media asset, the processing advances to Step 1308. At 1308, the media guidance application, implemented on control circuitry 404, determines whether the user has requested subtitles more than 50% of the time but less than 100% of the time when consuming media content in the language spoken in the media asset within a given time period. For example, the media guidance application, implemented on control circuitry 404, may determine whether the user 112 has requested subtitles more than 50% of the time but less than 100% of the time when consuming media content (e.g., watching movies, television shows, YouTube® video clips, etc.) in French. If the media guidance application determines that the user has requested subtitles more than 50% of the time but less than 100% of the time when consuming media content in the language spoken in the media asset, the processing advances to Step 1310. At 1310, the media guidance application, implemented on control circuitry 404, determines that the user has a beginner-level proficiency of the language spoken in the media asset. For example, the media guidance application, implemented on control circuitry 404, may determine that the user has a beginner-level proficiency of French when the user has requested subtitles 70% of the time.

If the media guidance application determines that the user has requested subtitles more than 25% of the time but less than 50% of the time when consuming media content in the language spoken in the media asset, the processing advances to Step 1312. At 1312, the media guidance application, implemented on control circuitry 404, determines whether the user has requested subtitles more than 25% of the time but less than 50% of the time when consuming media content in the language spoken in the media asset within a given time period. For example, the media guidance application, implemented on control circuitry 404, may determine whether the user 112 has requested subtitles more than 25% of the time but less than 50% of the time when consuming media content (e.g., watching movies, television shows, YouTube® video clips, etc.) in French. If the media guidance application determines that the user has requested subtitles more than 25% of the time but less than 50% of the time when consuming media content in the language spoken in the media asset, the processing advances to Step 1314. At 1314, the media guidance application, implemented on control circuitry 404, determines that the user has a very good command of the language spoken in the media asset. For example, the media guidance application, implemented on control circuitry 404, may determine that the user has a very good command of French.

If the user has requested subtitles less than 25% of the time when consuming media content in the language spoken in the media asset, the processing advances to Step 1316. At 1316, the media guidance application, implemented on control circuitry 404, determines that the user is a native speaker of the language. For example, the media guidance application, implemented on control circuitry 404, may determine that the user is a native French speaker. It will be evident to a person possessing ordinary skill in the art that the thresholds discussed above are merely examples, and that any suitable thresholds may be set for determining the level of proficiency required to comprehend the media asset.

It will be evident to a person skilled in the art that the steps described above with reference to FIG. 13 could be performed by any other devices shown in FIGS. 4 and 5. For example, process 1300 may be performed by control circuitry 404 as instructed by a media guidance application on user equipment 502, 504, 506, or first device 102, in order to play back media. In addition, one or more steps of process 1300 may be incorporated into or combined with one or more steps of any other process or embodiment (e.g., processes 600, 700, 800, and 1200).

The above embodiments generally discuss generating a translation for viewing by the user when the media content is in a language that is not native to the user. However, a person possessing ordinary skill in the art would recognize that the disclosure is not so limited, and that the translation may be generated when the media asset contains audio in a distinct accent that the user is not familiar with. For example, in a scenario where the audio in a media asset in a British accent, and the user viewing the media asset is American, the user may wish to receive a translation of the audio portion of the media asset to sufficiently comprehend the media asset. In some embodiments, the media guidance application may determine the location where the media asset originated and determine an accent likely to be present in the audio portion of the media asset, and based on the origination location, identify an accent likely to be present in the media asset. For example, the media guidance application, via control circuitry, may determine that the media asset originated in Ireland and determine that the media asset likely contains audio in English with an Irish accent.

In addition, based on the user profile, the media guidance application may determine the capability of the user to sufficiently comprehend various accents in a particular language. For example, the media guidance application may determine that the user is American and is likely to have difficulty sufficiently comprehending the media asset containing audio in an accent that is not American. Accordingly, the media guidance application may generate for display an output comprising the translation when the user is a native speaker of the language the media asset is in, but may not be familiar with the accent of the audio portion of the media asset. For example, when the user is viewing a media asset with audio containing an Irish accent and user is only familiar with American English, the media guidance application may generate for display an output comprising a translation of the media asset.

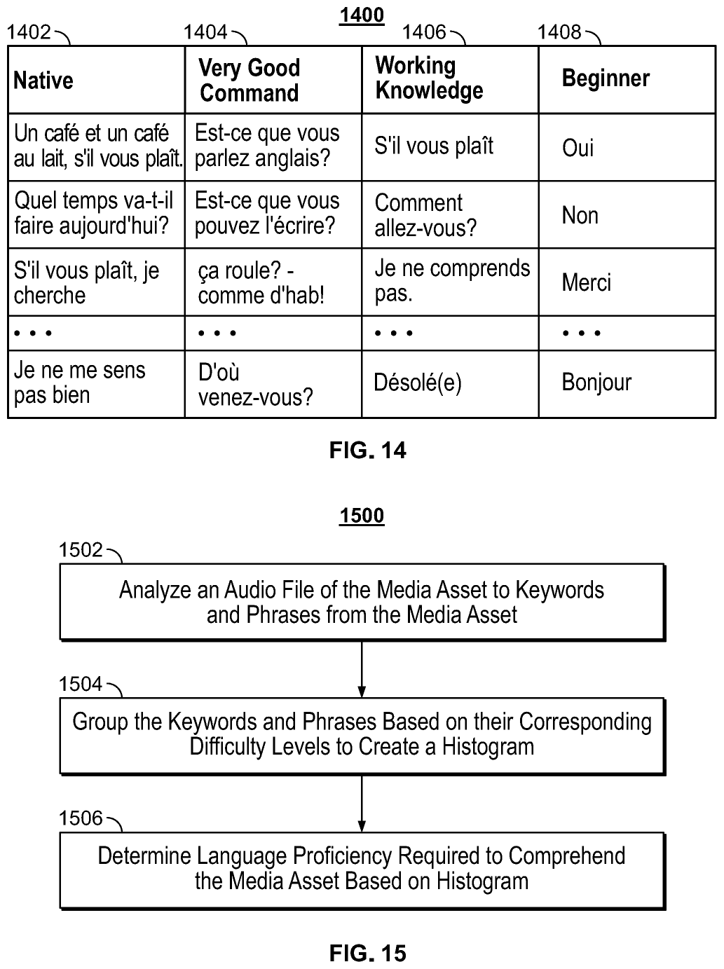

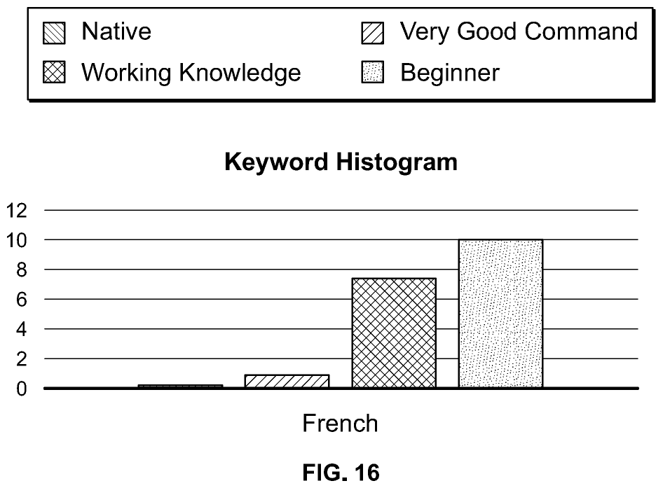

FIG. 14 is an illustrative example of a keyword data table for identifying a level of proficiency of a language required to comprehend a media asset, in accordance with some embodiments of the disclosure. In some embodiments, the database 108 stored on a remote cloud server 106 may store a pre-determined list of keywords and phrases categorized by the difficulty level in comprehending them for a plurality of languages. For example, as illustrated in FIG. 14, the table 1400 includes a list of keywords and phrases in French that are categorized based on the difficulty level required to comprehend them: Native 1402, Very Good Command 1404, Working Knowledge 1406, and Beginner level 1408. Each of the categories includes a plurality of keywords and phrases assigned to them; For example, the words “oui,” “non,” “merci,” and “bonjour” are categorized as only requiring a beginner-level proficiency to comprehend them. Similarly, the phrases, “Je ne me sens pas bien” and “S'il vous plait, je cherche” are categorized as requiring a native speaker level of proficiency to comprehend them. The media guidance application, via control circuitry 404, uses table 1400 to determine a level of proficiency of the language required to comprehend the media asset, as discussed below with reference to FIGS. 15 and 16.

FIG. 15 is a flowchart of illustrative actions for a media guidance application, implemented on control circuitry 404, to identify a level of proficiency of a language required to comprehend a media asset, in accordance with some embodiments of the disclosure. At 1502, the media guidance application, via control circuitry 404, reads and interprets metadata information corresponding to the media asset 104. For example, metadata information corresponding to the movie 104 may include a closed-captioning file which the media guidance application, implemented on control circuitry 404, may use to identify one or more keywords and phrases from the movie 104. For example, by analyzing a closed-captioning file included in metadata information corresponding to the movie “Jour de fête,” the media guidance application may identify the keywords and phrases such as “oui,” “merci,” “bonjour,” and “est-ce que vous parlez anglais?” spoken in the media asset. In some embodiments, where a closed-captioning file is not included in the metadata information corresponding to the media asset (e.g., a video clip uploaded by another user on social media platforms such as YouTube® or Facebook®), the media guidance application, via control circuitry 404, may transcribe the audio file corresponding to the media asset and identify the keywords and phrases by parsing the transcribed text file.

At 1504, the media guidance application, implemented on control circuitry 404, groups the most frequently used words and phrases based on their corresponding difficulty levels. For example, the media guidance application, via control circuitry 404, may compare the identified list of keywords and phrases against a predetermined list of keywords and phrases that have been previously categorized based on their difficulty levels (e.g., see FIG. 14, which illustrates a predetermined list of keywords and phrases that have been previously categorized based on their difficulty levels). For example, based on the comparison, the media guidance application, via control circuitry 404, may determine that the words “oui,” “merci,” and “bonjour,” require only a beginner-level proficiency of French, whereas the phrase “est-ce que vous parlez anglais?” requires a very good command of French.

At 1506, based on the frequency of keywords and phrases corresponding to the different difficulty levels, the media guidance application, via control circuitry 404, may determine a level of proficiency of the language required to comprehend the media asset. For example, the media guidance application, via control circuitry 404, may determine that most of the keywords and phrases spoken in the movie “Jour de fête” required only a working knowledge or beginner-level proficiency of French. Therefore, the media guidance application, via control circuitry 404, may determine that the user 112 needs to have only a working knowledge of French to comprehend the movie “Jour de fête.”

It will be evident to a person skilled in the art that the steps described above with reference to FIG. 15 could be performed by any other devices shown in FIGS. 4 and 5. For example, process 1500 may be performed by control circuitry 404 as instructed by a media guidance application on user equipment 502, 504, 506, or first device 102, in order to play back media. In addition, one or more steps of process 1500 may be incorporated into or combined with one or more steps of any other process or embodiment (e.g., processes 600, 700, 800, 1200, and 1300).

FIG. 16 is a graphical representation of a keyword analysis for identifying a level of proficiency of a language required to comprehend a media asset, in accordance with some embodiments of the disclosure. As illustrated in FIG. 16, the keywords and phrases identified based on metadata information corresponding to the media asset are categorized based on the difficulty levels required to comprehend those keywords and phrases. For example, FIG. 16 shows that the movie “Jour de fête” has 10 words per scene which require only a beginner-level knowledge of French, 7.8 words per scene that requires a working knowledge of French, 1 word per scene that requires a very good command of French and just 0.1 word per scene that requires the user to be a native speaker of French to comprehend the word or phrase. In the example illustrated in FIG. 16, the keywords and phrases identified from the movie “Jour de fête” are graphically represented and indicate that a user viewing the program may be able to comprehend the movie without needing a translation if they have a working knowledge of French. It will be evident to a person possessing ordinary skill in the art that the threshold ranges for various difficulty levels are intended to be merely examples, and that they may be adjusted as needed.

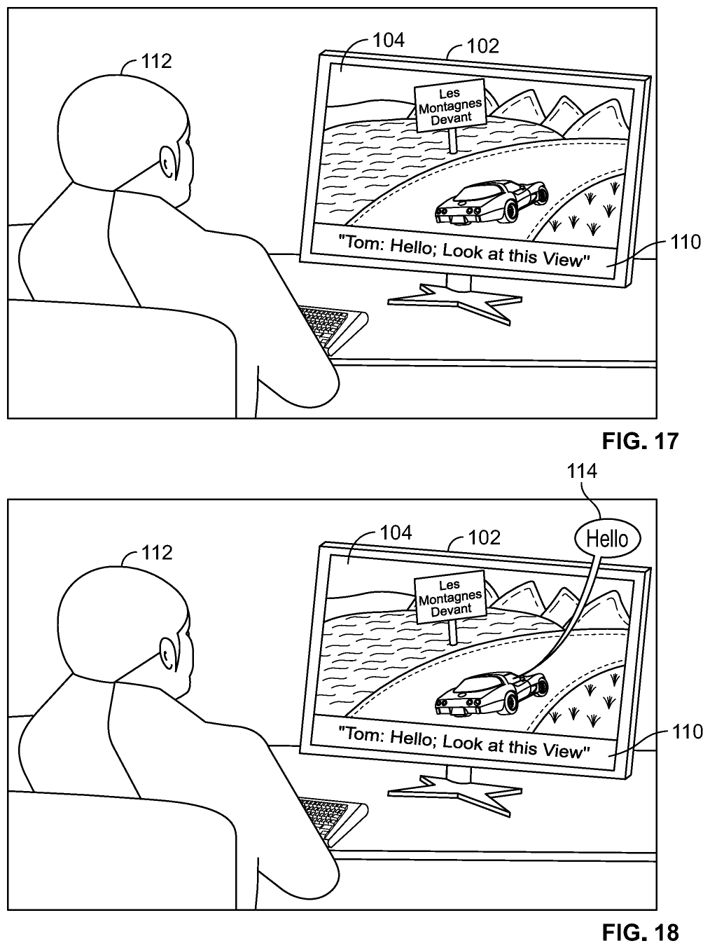

FIG. 17 shows an illustrative example of an application configuration, in accordance with some embodiments of the disclosure. In some embodiments, responsive to determining that the level of proficiency of the user is lower than the level of proficiency of the language required to comprehend the media asset, the media guidance application, via control circuitry 404, may generate for display an output comprising the translation. For example, when the media guidance application, via control circuitry 404, determines that the level of proficiency of the user is lower than the level of proficiency of French required to comprehend the movie “Jour de fete,” the media guidance application, via control circuitry 404, may generate for display at the first device 102, an output 104 comprising a subtitle track 110, so that the user 112 is able to comprehend the movie and have an improved viewing experience.

FIG. 18 shows an illustrative example of an application configuration, in accordance with some embodiments of the disclosure. In some embodiments, responsive to determining that the level of proficiency of the user is lower than the level of proficiency of the language required to comprehend the media asset, the media guidance application, via control circuitry 404, may generate for display, an output comprising the translation. For example, when the media guidance application, via control circuitry 404, determines that the level of proficiency of the user is lower than the level of proficiency of French required to comprehend the movie “Jour de fete,” the media guidance application, via control circuitry 404, may generate for display at the first device 102, an output 104 comprising a subtitle track 110 and/or a voice dubbing 114, so that the user 112 is able to comprehend the movie and have an improved viewing experience. Specifically, the media guidance application, implemented on control circuitry 404, may replace an original audio file corresponding to the movie with a second audio file which is an English or Spanish translation of the original audio file (i.e., translation to a language native to the user).

The above-described embodiments of the present disclosure are presented for purposes of illustration and not of limitation, and the present disclosure is limited only by the claims that follow. Furthermore, it should be noted that features and limitations described in any one embodiment may be applied to any other embodiments herein, and flowcharts or examples relating to any one embodiment may be combined with any other embodiments in a suitable manner, done in different orders, or done in parallel. Furthermore, it should be noted that while a first step may be based on and/or in response to a second step, such a relationship does not preclude additional steps occurring between the first and second steps. In addition, the systems and methods described herein may be performed in real time. It should also be noted the systems and/or methods described above may be applied to, or used in accordance with, other systems and/or methods.

1. A method of delivering a translation, the method comprising:
determining a language spoken in a media asset;
retrieving a profile for a user viewing the media asset;
determining, based on the profile, whether the language is a language native to the user;
in response to determining that the language is native to the user, generating an output comprising the media asset;
in response to determining that the language is not native to the user:
determining a level of proficiency of the language required to comprehend the media asset;
identifying, based on the profile, a level of proficiency of the user corresponding to the language;
determining whether the level of proficiency of the language required to comprehend the media asset is equal to, higher than, or lower than the level of proficiency of the user;
in response to determining that the level of proficiency of the user is equal to or higher than the level of proficiency of the language required to comprehend the media asset, generating an output comprising the media asset;
in response to determining that the level of proficiency of the user is lower than the level of proficiency of the language required to comprehend the media asset, requesting a translation to a language native to the user; and
in response to receiving the translation, generating an output comprising the translation.

2. The method according to claim 1, wherein the level of proficiency of the user corresponding to the language is identified by:
generating a prompt requesting the level of proficiency of the user corresponding to the language; and
in response to the prompt, receiving an input from the user indicating the level of proficiency of the user corresponding to the language.

3. The method according to claim 1, wherein the level of proficiency of the user corresponding to the language is identified based on information retrieved from a database storing one or more of: online activity of the user, a media asset viewing history of the user, a music selection history of the user, an amount of time spent reading a text item written in the language, an amount of time spent creating a text item written in the language, and an amount of time spent editing a text item written in the language.

4. The method according to claim 1, wherein the level of proficiency of the user corresponding to the language is identified based on previous requests for subtitles submitted by the user.

5. The method according to claim 1, wherein determining the level of proficiency of the language required to comprehend the media asset comprises:
generating a list of most frequently said words and phrases within the media asset;
grouping the list of most frequently said words and phrases based on a language complexity; and
determining the level of proficiency of the language required to comprehend the media asset based on the grouping.

6. The method according to claim 1, wherein:
the media asset includes a video file and an audio file; and
generating the output comprising the media asset comprises streaming the video file and the audio file to a first device accessible by the user.

7. The method according to claim 1, wherein:
the media asset includes a video file and an audio file; and
generating the output comprising the translation comprises:
streaming the video file and the audio file to a first device accessible by the user; and
rendering a visual representation of the audio file of the media asset synchronized with the video file of the media asset at the first device.

8. The method according to claim 1, wherein:
the media asset includes a video file and an audio file; and
generating the output comprising the translation comprises:
replacing the audio file of the media asset with a second audio file, wherein the second audio file is in the native language of the user and is synchronized to the video file of the media asset; and
streaming the video file and the second audio file to a first device accessible by the user.

9. The method according to claim 1, wherein the translation comprises at least one of subtitles and audio recording in the native language.

10. The method according to claim 1, wherein the language spoken in the media asset is determined based on a country of origin of the media asset.

11. A system for providing a translation, the system comprising:
memory storing a profile for a user viewing a media asset; and
control circuitry configured to:
determine a language spoken in a media asset;
retrieve the profile from the memory;
determine, based on the profile, whether the language is a language native to the user;
in response to determining that the language is native to the user, generate an output comprising the media asset;
in response to determining that the language is not native to the user:
determine a level of proficiency of the language required to comprehend the media asset;
identify, based on the profile, a level of proficiency of the user corresponding to the language;
determine whether the level of proficiency of the language required to comprehend the media asset is equal to, higher than, or lower than the level of proficiency of the user;
in response to determining that the level of proficiency of the user is equal to or higher than the level of proficiency of the language required to comprehend the media asset, generate an output comprising the media asset;
in response to determining that the level of proficiency of the user is lower than the level of proficiency of the language required to comprehend the media asset, request a translation to a language native to the user; and
in response to receiving the translation, generate an output comprising the translation.

12. The system according to claim 11, wherein the control circuitry is further configured to identify the level of proficiency of the user corresponding to the language by:
generating a prompt requesting the level of proficiency of the user corresponding to the language; and
in response to the prompt, receiving an input from the user indicating the level of proficiency of the user corresponding to the language.

13. The system according to claim 11, wherein the control circuitry is further configured to identify the level of proficiency of the user corresponding to the language based on information retrieved from a database storing one or more of: online activity of the user, a media asset viewing history of the user, a music selection history of the user, an amount of time spent reading a text item written in the language, an amount of time spent creating a text item written in the language, and an amount of time spent editing a text item written in the language.

14. The system according to claim 11, wherein the control circuitry is further configured to identify the level of proficiency of the user corresponding to the language based on previous requests for subtitles submitted by the user.

15. The system according to claim 11, wherein the control circuitry is further configured to determine the level of proficiency of the language required to comprehend the media asset by:
generating a list of most frequently said words and phrases within the media asset;
grouping the list of most frequently said words and phrases based on a language complexity; and
determining the level of proficiency of the language required to comprehend the media asset based on the grouping.

16. The system according to claim 11, wherein:
the media asset includes a video file and an audio file; and
the control circuitry is further configured to:
generate the output comprising the media asset comprises streaming the video file and the audio file to a first device accessible by the user.

17. The system according to claim 11, wherein:
the media asset includes a video file and an audio file; and
the control circuitry is further configured to generate the output comprising the translation by:
streaming the video file and the audio file to a first device accessible by the user; and
rendering a visual representation of the audio file of the media asset synchronized with the video file of the media asset at the first device.

18. The system according to claim 11, wherein:
the media asset includes a video file and an audio file; and
the control circuitry is further configured to generate the output comprising the translation by:
replacing the audio file of the media asset with a second audio file, wherein the second audio file is in the native language of the user and is synchronized to the video file of the media asset; and
streaming the video file and the second audio file to a first device accessible by the user.

19. The system according to claim 11, wherein the translation comprises at least one of subtitles and audio recording in the native language.

20. The system according to claim 11, wherein the control circuitry is further configured to determine the language spoken in the media asset based on a country of origin of the media asset.

21-50. (canceled)
